(19) United States
(12) Patent Application Publication
(10) Pub. No.: US 2016/0329803 A1
(43) Pub. Date: Nov. 10, 2016

(54) Magnetic engine

(71) Applicant: NAVIS S.R.L., Monte San Savino - Arezzo (IT)

(72) Inventors: Mario Burigo, Monte San Savino - Arezzo (IT); Gianni Santarelli, Arezzo (IT); Fabrizia Di Mascio, Monte San Savino - Arezzo (IT); Marco Celso Matteoni, Torino (IT)

(21) Appl. No.: 15/181,444

(22) PCT Filed: Jan. 8, 2015
(86) PCT No.: PCT/IB2015/050142

§ 371 Date: Jun. 14, 2016

(30) Foreign Application Priority Data
Feb. 4, 2014 (IT) AR2014A000006

(51) Int. Cl. H02K 41/06; H02K 11/21

(52) U.S. Cl. CPC H02K 41/06; H02K 11/21

(57) ABSTRACT

The present invention relates to a motor for the transformation of electrical energy into mechanical motion, comprising: • at least one subsystem called “inducer” which includes a sequence of individually controllable electromagnets and interspersed with non-ferromagnetic elements, • at least one subsystem called “induced” which includes ferromagnetic material, • at least one source of power supply to provide electric current to each electromagnet, in which “inducer” and “induced” subsystems or can rotate about at least one axis of rotation. The rotation is due to the torques generated in succession by the magnetic fields of the electromagnets in the neighborhood of the contact point or the minimum distance between the two subsystems. The direction and speed of rotation are determined by the direction and intensity of the current with which the electromagnets are powered.

### TECHNICAL FIELD

The present invention relates to the field of mechanical engineering.

In particular, the present invention finds preferred application in the field of engines or of the apparatuses for the production of mechanical movement from another form of energy.

The invention relates in particular to a engine capable of transforming electrical energy into mechanical motion. The resulting movement can be continuous or step by step type.

### BACKGROUND

There are various types of systems that use electromagnetism to generate forces and/or torques. Most of these systems were designed in the second half of 1800 and were later refined to improve their efficiency.

These include electric motors and electromagnets. An electric motor is essentially constituted by a circuit placed on a metallic armor, which can rotate (rotor) immersed in a magnetic field produced by magnets (stator). When the circuit is closed, it generates a magnetic field that interacts with that of its magnets, cause the armature to rotate. Approximately 70% of the electric motors currently in operation are three-phase asynchronous, or induction type. The winding on the stator is powered directly from the AC line, the rotor is the seat of induced currents in the rotating magnetic field of the stator. The torque due to the actions between the stator field and the rotor currents will start the rotor. It is used for many applications in industry, transport (rail, metro and tram) in household appliances and so on. DC engines too are still very popular, they continue to be used in industry as well as in transportation.

They are constituted by a stator and a rotor, their functioning is essentially based on the continuous switching of the supply current to keep the rotor magnetic field armature always orthogonal to the stator and thus ensure the continuous and constant presence of the force (and torque) which tends to align them and which generates the rotation of the rotor.

By “opening” the rotor and the stator it is possible to have “linear” electric motors that allow the translation instead of the rotation between the stator and rotor. They have various industrial applications as well.

There are then the electromagnets, which are devices consisting of a soft iron open core, on which a coil of conducting wire is wound; by sending an electric current on that, the nucleus acquires a magnetization that ceases when the current ceases, except for hysteresis. In general, the electromagnets are grouped into two main categories depending on the function.

The first includes the so-called field electromagnetic, the purpose of which is to create, in a restricted area and well-defined space, a magnetic field of the wanted intensity and induction.

The second category includes the so-called electromagnetic of force, intended to produce appropriate attractions on ferromagnetic objects. The electromagnets used in relays and similar devices are electromagnetic of force as well as the lifting electromagnets, applied to cranes, bridge cranes and the like to handle and transport scrap iron and metal bars.

The electric motors are subject to some drawbacks such as electromagnetic interference, high frequency currents, high inrush currents, costs and performances.

The electromagnets are used only when there is a limited mechanical work required.

These and other limitations and problems inherent in the architecture of the motors and electromagnets disappear when this is completely revised into a completely different structure as shown in the present patent.

### OBJECTIVES AND SUMMARY OF THE INVENTION

The present invention is set forth and characterized in the main claim.

Other features of the present invention are expressed in the secondary claims.

It is the aim of the present invention to present a motor that uses the magnetic attraction and possibly the repulsion to generate forces and/or torques for the production of mechanical work used for driving or braking that overcomes some of the drawbacks of the known art.

In particular, it is object of the present invention to provide a motor that can provide mechanical work for generic propulsion systems suitable for vehicles or movement or displacement means using wheels or rotating elements. These and other objects are achieved by means of an innovative motor comprising the features of the annexed claims, which form an integral part of the present description.

The invention will now be described in relation to one or more embodiments. The description of such embodiments is not selected to be understood that the invention is limited thereto. On the contrary, according to the present disclosure, those skilled in the art should appreciate variations and equivalents of the embodiments. Such variations and equivalent embodiments are also intended to fall within the scope of the present invention.

The basic idea of the present invention is to exploit with continuity the magnetic forces that are created between a component or subsystem (“inducer”) that includes electromagnets appropriately arranged to generate a sequence of electromagnetic fields and a ferromagnetic component or subsystem (“induced”) that is subjected to said electromagnetic fields. In order to produce mechanical work it is necessary that the forces generated have non-null components in-the direction of the displacement. And this displacement is obtained through at least one rotating element, which can be either the inducer or the induced subsystem, on which the magnetic forces can exert moments to produce the rotation. The rotating element also allows to repeat this displacement in succession and to generate mechanical work with continuity. Differently from the conventional electric motors and electromagnets, the magnetic forces generated by each electromagnets of the inducer subsystem are exploited in sequence when such electromagnets are in the vicinity of the contact or the minimum distance between with the induced subsystem, where the magnetic forces are greater. The need to have at least one rotating element, be it inducer or induced subsystem, allows this magnetic motor in the variants that combine rotating inducers coupled to induced which can be either rotating or non-rotating and induced with rotating elements coupled to inducers which can be either rotating or not rotating.

In the present invention each electromagnet will be active only when it will be in the vicinity of the contact zone and then only for a fraction of the rotation of the rotating component. That is, the electric current can circulate in the coil of each electromagnet only during a fraction of the rotation. The engine may have good efficiency for converting electrical energy into mechanical energy due to the reduced distance between the elements where the magnetic forces are generated and it is possible to build motors easily controllable in speed of rotation/translation, torque and power.

The ferromagnetic component may comprise permanent magnets to exploit the magnetic fields generated by them that interacting with the magnetic fields generated by the inducer subsystem allow to obtain even the repulsive forces between the poles of the same sign and to obtain more attractive forces between poles of opposite sign.

Efficiency in converting electrical energy into mechanical energy will increase by exploiting magnetic torques in areas where inductor and induced are very close and no electricity is wasted in electromagnets where the distance between the inductor and induced is greater.

Such a system can then generate forces and/or torques between rotating elements or between rotary and non-rotary elements. It uses the electromagnets whose magnetic fluxes can be controlled by varying in a suitable way the currents in the coils, also inverting them, in order to generate and vary the attraction forces and compensate for any hysteresis and, in the case of induced subsystem comprising permanent magnets, to be able to generate and vary the forces of repulsion.

In preferred embodiments, wheels, rails and rolling elements can have the shape and profile of the types normally used in the field of transport and in the industry (conical, straight, s-shaped, toothed, etc . . . ).

In one embodiment, the invention relates to an engine comprising:
at least one rail where a series of electromagnets are arranged in sequence (“inducer” subsystem);
a vehicle or a movement/displacement mean of any type to be able to move on said rail with at least one rotating element comprising ferromagnetic material (“induced” subsystem);
A power supply network;

If there are more than one rail, then to set up the tracks, the distance (gauge) between them depends on the type of vehicle or movement or displacement mean intended for their use.

These rails can be either buried or on the surface, possibly equipped with spacer elements and the structural support (crosses).

In this embodiment, each rail comprises a plurality of electromagnets and a plurality of electrically insulating elements.

The rails comprise a sequence of electromagnets separated with non-ferromagnetic elements in the longitudinal direction. Each electromagnet is connected to the supply grid that uses one or more actuators and possibly one or more sensors and control units.

The electromagnets and non-ferromagnetic elements will have sections and forms compatible with the type of rail used, and the type of vehicle or movement or displacement mean in use (railway, Burback, decauville, flat rack , etc . . . ).

A vehicle or movement or displacement mean with wheels or rotating elements that include ferromagnetic material (such as a simple railway wagon), possibly coated with plastic material or any other material deemed appropriate, positioned on the rails, is made to move along them in both possible directions by circulating currents in the coils of some of the electromagnets in order to produce magnetic fields that will affect, with different intensity, instant by instant, the various parts of the wheel or rotating elements thus generating magnetic attractive forces. The forces that have directions that do not pass through the axis of rotation generate torques that give rise to a rotation of the induced subsystem around its axis of rotation and to a translation with respect to the inducer.

Each electromagnet will be designed with section of the core, contact areas towards the armature, number of turns in the coils, etc . . . , depending on the application and the required characteristics of the engine.

By adjusting the intensity of the current flowing in the coils of the electromagnets it is possible to control the module of the attractive forces and the driving or braking torques transmitted to the rotating elements or wheels.

The electromagnets can be controlled in sequence with a certain speed of translation or it may be possible to identify time to time the electromagnets to be controlled using position sensors.

The progress of the vehicle through driving torques supplied to the rotating elements or the wheels is obtained by activating the electromagnets immediately in front of those corresponding to the areas of contact of the rail with the rotating elements or wheels, and deactivating the electromagnets on the rear.

The number of electromagnets to be activated depends on several factors such as the distance between inducer and induced subsystems, the intensity of the current which feeds the electromagnets and the size of the electromagnets themselves, all magnitudes which in turn are a function of the type of application, and then of the required torques.

Electromagnetic forces (and torques) that are generated depend on all the parameters listed above and the best combination of these parameters must then be determined based on the requirements and is borne by the user or, automatically, by a possible control system.

The attractive forces of the electromagnets active, each acting predominantly through the air gap on the portion of the rotating element or wheel subject to the corresponding flux, produce torques whose resultant determines the rotation of each rotating element or wheel of the vehicle in the wanted direction.

It may also be possible to send currents in the opposite direction in the magnets in the contact zone, or immediately preceding it in the direction of motion, to compensate for any hysteresis that could generate resistance torques.

The braking is obtained in a similar manner by activating the electromagnets immediately subsequent to those in the area of contact with the rotating elements or wheels with the rail and deactivating the electromagnets preceding. The resulting torque in this case will be in the opposite direction of the previous one, opposing the motion of the vehicle until to stop it. Continuing in the same action the vehicle can be made to move backwards.

Then maintaining active the electromagnets in the area in contact where there is maximum attraction between rotating elements or wheels and rail the vehicle is kept on hold.

In another embodiment the invention relates to an engine comprising:
at least one rotating element or wheel specially made as described below (“inducer” subsystem) eventually mounted on vehicles or movement/displacement means
at least one rail comprising ferromagnetic material (“induced” subsystem);
A power supply network;

The wheels, the rotating elements and rails, may have the shape and profile of those currently in use in the transport sector and industry (conical, straight, s-shaped, toothed, etc . . . ).

If there are more than one rail, then to set up the tracks, the distance (gauge) between them depends on the type of vehicle or movement or displacement mean intended for their use.

These rails can be either buried or on the surface, possibly equipped with spacer elements and the structural support (crosses).

The rotating element or wheel comprises a sequence of electromagnets arranged radially or otherwise along the circumference separated by non-ferromagnetic elements. Each electromagnet is connected to the supply network, make use of one or more actuators and possibly one or more sensors and control units.

In this case the operation is substantially specular to that illustrated previously with the generation of magnetic attraction forces between the ferromagnetic material of the rail and rotating element or wheel necessary to the movement (or the brake or the parking), generated by the electromagnets of the rotating element or wheel.

Also in this case and in all variations covered by the claims, the electromagnets will be designed with sections of the core, the number of turns in the coils, etc . . . , depending on the application and the characteristics of the wanted engine.

By varying the intensity of the current flowing in the coils of the electromagnets it is possible to control the attractive forces and the torques, for driving and/or braking the inductor. The electromagnets may be activated in sequence with a certain angular speed of rotation or the electromagnets to be activated time to time could be determined using the signals of any sensors.

The movement of a vehicle equipped with these rotating elements or wheels is obtained by activating the electromagnets in the sequence immediately preceding, in the direction of motion, those corresponding to the areas of contact with the rails, possibly identified by sensors, and disabling in sequence the electromagnets thereafter. The attractive forces of the active electromagnets, each acting through the air gap, on the portion of rail affected by the corresponding fluxes, produce torques whose resultant determines the rotation of each rotating element or wheel of the inductor on the vehicle and the advancement of the same.

It may also be possible to send the currents in the opposite direction in the magnets in the contact zone, or immediately thereafter in the direction of motion, to compensate for any hysteresis that could generate resistance torques.

The braking is obtained in a similar manner by activating the electromagnets in sequence immediately subsequent, in the direction of motion, of those in the area of contact with the rails and deactivating the other. The resulting torque in this case will be contrary to the previous one, opposing the motion of the vehicle to brake it. Continuing in the same action the vehicle can be made to move backwards.

Then, keeping active the electromagnets in the contact area between wheel and rail, the vehicle is kept on hold.

The wheel-rail configurations presented so far can be applied in the transport and handling of things or people but are only part of the configurations that exploit to the fullest possible extent the construction principle of the present invention of transforming electrical energy into mechanical, the configurations where both the inducer and the induced subsystems include rotating elements.

In one embodiment of the invention it relates to an engine comprising:
at least one rotating element named “inducer” subsystem, as described below, that can generate electromagnetic fields;
at least one rotating element named “induced” subsystem in contact with the “inducer”;
A power supply network;

The wheels or rotating elements may have the shape and profile of those currently in use in the transport sector and industry (conical, straight, s-shaped, toothed, etc . . . ).

The “inducer” subsystem comprises a sequence of electromagnets arranged radially or otherwise along the circumference separated by non-ferromagnetic elements. Each electromagnet is connected to the supply network by actuators and may possibly use one or more sensors and control units.

The transformation of electrical energy into mechanical energy and the consequent rotation of one or both elements is achieved by feeding in sequence the electromagnets of the inductor immediately prior to the zone of contact and turning off the electromagnets thereafter. The attractive forces that develop between elements of the inductor and the induced that have directions that do not pass through the axis of rotation generate rotation torques.

Varying the intensity of the current flowing in the coils of the electromagnets it is possible to vary the attractive force and, consequently, the torques, thus resulting in the variation of speed of rotation of the elements.

It may also be possible to send currents in the opposite direction in the electromagnets in the contact zone, or immediately following in the direction of motion, to compensate for any hysteresis that could generate resistant torques.

In other embodiments of the invention there may be rotating elements placed one inside the other and the inductor can be either the inner wheel or the outer wheel.

In all previous versions, the inducer subsystem may comprise not a sequence, in the longitudinal direction, of individual electromagnets, but a sequence of two or more electromagnets placed side-by-side, and separated by one or more non-ferromagnetic elements. Each electromagnet can use one or more sensors and control units.

The presence of two adjacent electromagnets afferent to a single portion of the inducer subsystem, even with a small inclination with respect to radial direction, can also allow to modulate the overall attractive force along the transverse direction. making possible to improve the magnetic control of the alignment of the two elements of the system, whether they are wheel and rail or two generic rotating elements.

Another variation that affects all the illustrated embodiments includes an “induced” subsystem comprising permanent magnets. These permanent magnets contribute to the functioning of the system in two ways:
the permanent magnets who find themselves before the contact area (or the point of shortest distance between the “inducer” and “induced” subsystems) contribute with their forces of attraction to the torque originated by the active electromagnets of the “inducer” subsystem;
at the same time, sending a current in the opposite direction to the electromagnets which are after the contact area (or the point of shortest distance between “inducer” and “induced” subsystems), it is also possible to take advantage of the repulsive forces that are created between magnets of opposite polarity, to generate a further torque which is added to the previous one.

Regarding the configurations in which the “inducer” subsystem is a wheel or a rotating element, it can be assembled in a different form; this form comprising a circular rotating external or internal crown, comprising the electromagnets and non-ferromagnetic elements of separation, and a fixed, internal or external part. including fixed connections and contacts with the power supply network.

The motion of the wheels or rotating elements is as described in the previous embodiments with the difference that, in this case, permanent connection of all the electromagnets of the wheel with the supply network are not necessary: there are only an adequate number of connections (made through brushes or equivalent components) related to the portion of the wheel that can actually contribute to the motion and then only the electromagnets pertaining to that portion of the wheel are temporary connected, to the power source.

For all the described embodiments, the various components of the system that comprises the part of ferromagnetic material, the core of the electromagnets , permanent magnets and any insulating materials and non-ferromagnetic materials, etc . . . , can each contain different elements, and not necessarily be a single homogeneous element, as is the case for electric motors or for the common electromagnets . This allows having the advantages also in terms of weight and efficiency.

The configuration, architecture and dimensions of the components of the present invention will depend on the applications.

For all the variants described and in particular for those where the “induced” subsystem comprises permanent magnets, it is also possible to use the classical U-shaped electromagnets arranged longitudinally in an appropriate way, in order to take advantage of both poles to contribute both to the attractive and repulsive forces.

For all the embodiments it would also be possible to use not only the direct current but also the alternate currents of appropriate frequency to generate the desired magnetic fields.

For all the embodiments, the dimensions of the various components and in particular the flow areas of the electromagnets and any permanent magnets can vary considerably depending on the application and the required characteristics of the motor or brake.

For all the embodiments there may be more inducer elements for each induced or more induced for each inducer.

For all embodiments the activation and deactivation of the electromagnets may occur with some time in advance to account for system delays.

For all the variants described there can be an “induced” subsystem whose rotating elements comprise components which can further rotate around them.

For all the variants described, the motor can be used as a brake.

### BRIEF DESCRIPTION OF THE DRAWINGS

The invention will be described below with reference to non-limiting examples, which are provided for only explanatory purposes and without limiting to the attached drawings. These drawings illustrate different aspects and embodiments of the present invention and, where appropriate, numeric references illustrating structures, components, materials and/or similar elements in different figures are indicated by similar numeric references.

FIG. 1 shows one embodiment of the present invention in which the “inducer” subsystem takes the form of a rail and the “induced” takes the form of a wheel.

FIG. 1a shows the possible small size of the electromagnets in the direction of the motion.

FIG. 2 shows a basic scheme of the engine to convert electrical energy into mechanical energy according to the present invention.

FIG. 2a shows a scheme of the engine to convert electrical energy into mechanical energy according to the present invention which include sensors and control units.

FIGS. 3a, 3b, 3d show three consecutive phases of the motion of an “induced” subsystem as a wheel along an “inducer” subsystem as rail. The motion is in the direction of positive “x”.

FIG. 3c shows a detail of the area of contact between the “inducer” and “induced” subsystems during the motion of the “induced”.

FIG. 3e shows a variant of the first embodiment without control unit.

FIGS. 3f , 3g , 3h show three consecutive phases of the counterclockwise motion of the “induced” in an embodiment where both “inducer” and “induced” take a circular shape, are coplanar with each other, the “inducer” is fixed and the “induced” moves following a roto-translational motion on the inner perimeter of the “inducer”.

FIG. 4 shows the side view, front view and top view of a “U-shaped” electromagnet that can be used in all the embodiments of the present invention.

FIG. 4a shows a cylindrical electromagnet that can be used in all the embodiments of the present invention.

FIG. 4b shows the section view of two rails made according to the present invention and the use of “U-shaped” electromagnets.

FIG. 5 shows an embodiment in which the “inducer” takes a circular shape and the “induced” takes the shape of a rail.

FIG. 5a shows a possible side view and a front view of the “inducer” used in the configuration shown in FIG. 5.

FIGS. 5b, 5c, 5d show three consecutive phases of the motion of the system shown in FIG. 5, in the direction of positive x.

FIGS. 6a, 6b, 6c show three consecutive phases of the motion of the inductor (counterclockwise) and induced (clockwise), in an embodiment in which both elements take a circular shape.

FIG. 6d shows an application of the present invention to a system constituted by gear wheels.

FIGS. 6e, 6f show two consecutive phases of the movement of the “inducer” and of the induced subsystems (both clockwise), in one embodiment in which both the “inducer” and “induced” take a circular shape, with the “induced” located internally to the inductor and coplanar to it and both rotate around the respective axis of rotation.

FIG. 6g shows a variant of the embodiment seen in FIGS. 6e, 6f, in which the “inducer” comprises an inner movable part comprising the electromagnets with their respective electrical contacts and an outer fixed part comprising external connections to the power supply less in number than that of the electromagnets.

FIG. 6h shows an embodiment in which the “inducer” and the “induced” take a circular shape, with the “inducer” located internally to the armature and coplanar to it and both rotate around the respective axis of rotation.

FIGS. 7a, 7b , 7c , show three consecutive phases of the operation of an “inducer” that include a movable inner part comprising electromagnets with their respective electrical contacts and a fixed outer part comprising external connections to the power supply less in number than that of the electromagnets.

FIG. 8 shows the sectional view of two rails made according to the present invention using pairs of electromagnets, instead of individual electromagnets, for controlling the attitude of the “induced” also in the transverse direction (z).

FIG. 9 shows a variant of the embodiment illustrated in FIG. 1, in which the “induced” is equipped with permanent magnets.

FIG. 10 shows a detail, with a side view, of a possible arrangement of the electromagnets to build an “inducer” subsystem in the shape of a rail.

FIG. 11 shows a variant of the embodiment illustrated by FIG. 6a in which the “induced” is equipped with permanent magnets.

FIG. 11b shows a variant of the embodiment illustrated by FIG. 6e in which the “induced” is equipped with permanent magnets.

FIG. 12 shows an embodiment with single a “induced” subsystem and more coplanar “inducer” subsystems arranged externally to the “induced” with “inducers” and “induced” that can rotate around their respective axes of rotation.

FIG. 12a shows an embodiment with a single “induced” subsystem and more coplanar “inducer” subsystems arranged internally to the “induced”, with “inducers” and “induced” that can rotate around their respective axes of rotation.

FIG. 13 shows an embodiment with a single “inducer” subsystem and more coplanar “induced” subsystems, arranged externally to the “inducer”, with “inducer” and “induced” subsystems that can rotate around their respective axes of rotation.

FIG. 13a shows an embodiment with a single “inducer” subsystem and more coplanar “induced” subsystems arranged internally to the “inducer”, with “inducer” and “induced” subsystems that rotate around their respective axes of rotation.

FIG. 14 shows an embodiment with a single “induced” subsystem and more “inducer” subsystem non-coplanar and arranged externally to the “induced”, with “inducer” and “induced” subsystems that rotate around their respective axes of rotation.

FIG. 15 shows a type of configurations where the rotating elements of the “induced” subsystem in turn comprise components that can also rotate around them.

### DETAILED DESCRIPTION OF THE INVENTION

Various modifications and alternative constructions are possible for this invention and some of them are shown in the drawings and will be described in detail below. This description is not to be understood as an intention to limit the invention to the individual embodiments illustrated but, on the contrary, the invention intends to cover all the changes and alternative or equivalents configurations that fall in the field of the invention as defined in the claims.

The use of “such as”. “etc.”, “or” indicates non-exclusive alternatives without limitation unless otherwise specified. The use of “include” or “includes” means “includes or consists of, but not limited to”, unless otherwise specified.

The term “sensor” refers to a device that converts a physical quantity into an electrical signal usable by the control system.

The term “actuator” refers to a device that converts the control signals provided by a component or section of a system (in the form electric signal) in actions on the system itself.

The term “control subsystem” refers to the part of the system responsible for the control of the induction system so as to generate the forces and torques required to achieve the desired motion.

The figures and the images related to the following descriptions are only intended to illustrate the operation of the various embodiments and the elements that comprise them.

It is hereafter described an engine that converts electric energy into mechanical energy by means of the interactions created between the elements generating magnetic fields and the elements subject to these magnetic fields.

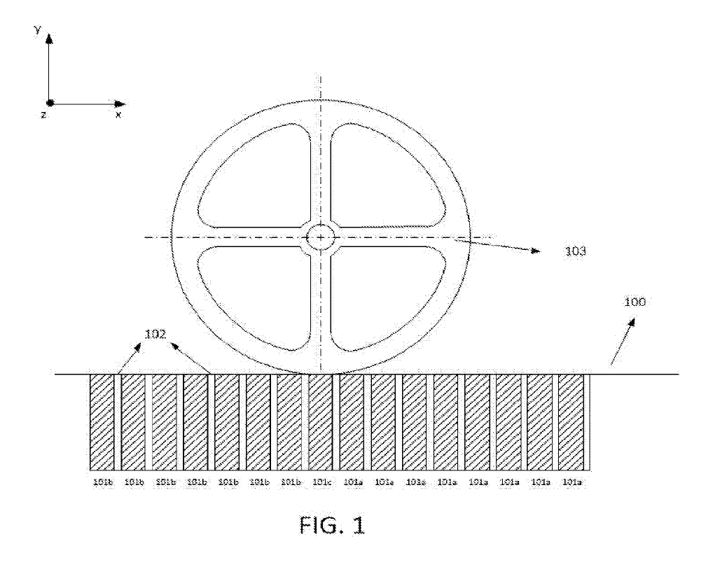

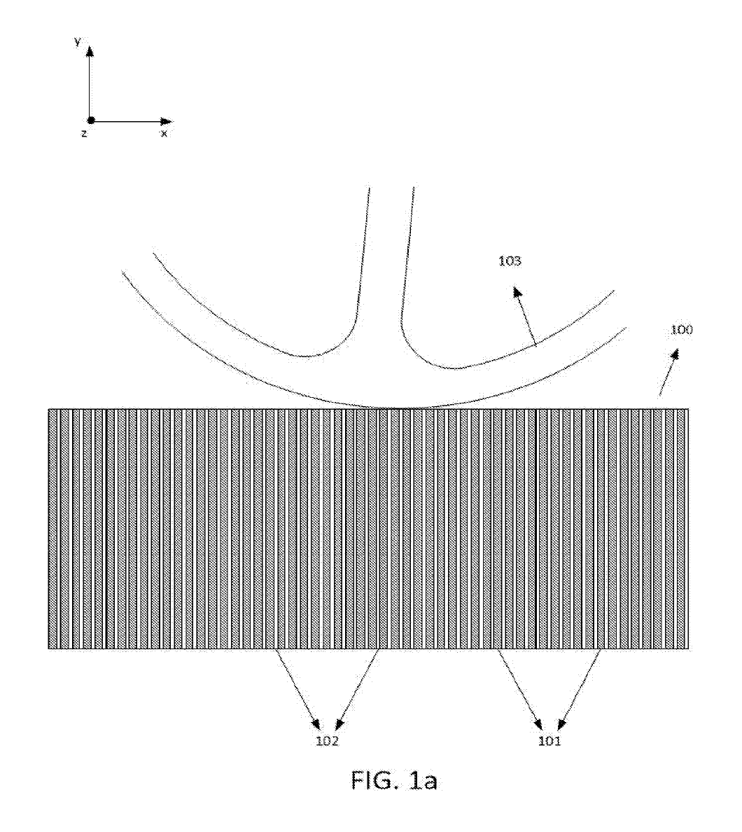

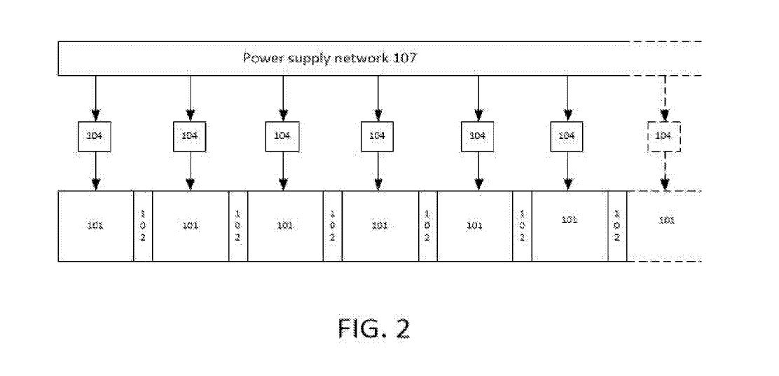

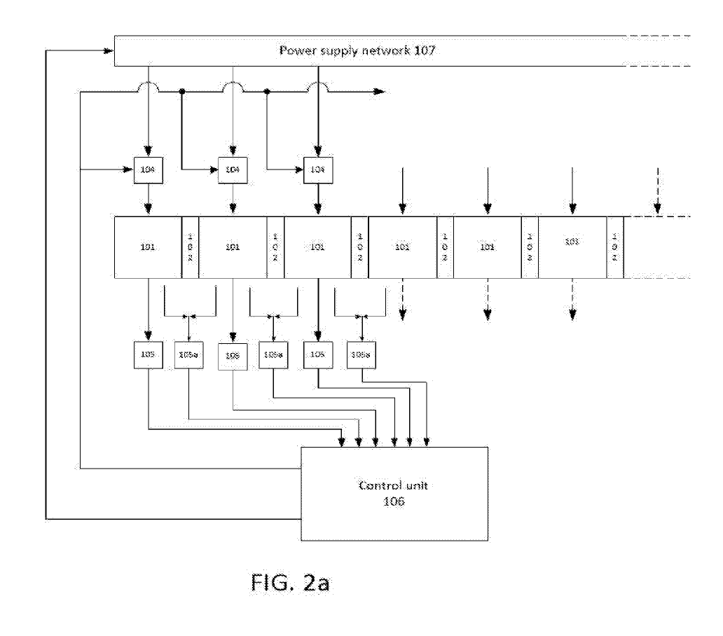

In one embodiment, shown schematically in FIG. 1 and FIG. 2, the invention comprises:
at least one rail 100 that is the “inducer” element of the magnetic fields;
a wheel or rotating element (“induced”) 103 which is subject to the effects of the magnetic fields generated by the “inducer”. It may possibly be a part of a vehicle or of a movement/displacement mean;
a power supply network 107;

With reference to FIG. 1, the rotating element 103 comprises ferromagnetic material, the rail 100 comprises a sequence of electromagnets 101 separated with non-ferromagnetic elements 102.

As shown in FIG. 1a, the size of the electromagnets in the direction of the relative motion between the “inducer” and the “induced” can be much smaller than indicated in FIG. 1 in order to make better use of the forces and torques that are generated.

In FIG. 1 and in all the figures that follow, the relative sizes of the electromagnets and the other elements depicted, are intended only to illustrate the operation of the various embodiments; in real applications they may also assume relative proportions quite different and, for example, there may be an electromagnet every a tenth of a degree of the arc of the subtended circle.

In FIG. 2 and FIG. 2a are shown the block diagrams that highlight the main components of the system and the interactions between them. In particular, FIG. 2a refers to the more general case with the presence of actuators 104, sensors 105 and 105a, and control unit 106, while FIG. 2 is a feasible solution when the presence of these elements is not necessary. In particular, regarding the sensors, in addition to the sensors directly connected to the electromagnets and indicated with 105, there can be also sensors associated to variables of other type, indicated with 105a, not directly related to the state of the electromagnets, such as the speed of the “induced”, the pressure of the “induced” on the “inductor”, etc. . . . In such schemes, not limited to a wheel-rail configuration. the electromagnets are generally indicated by the number 101.

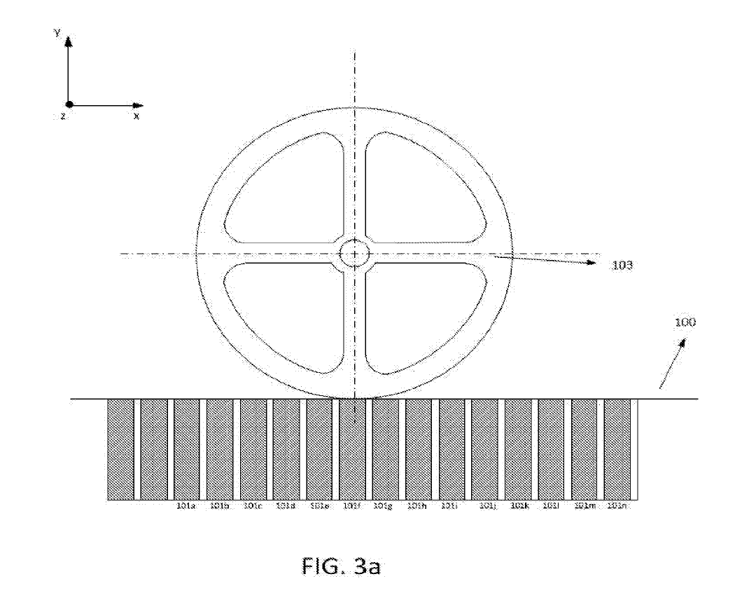

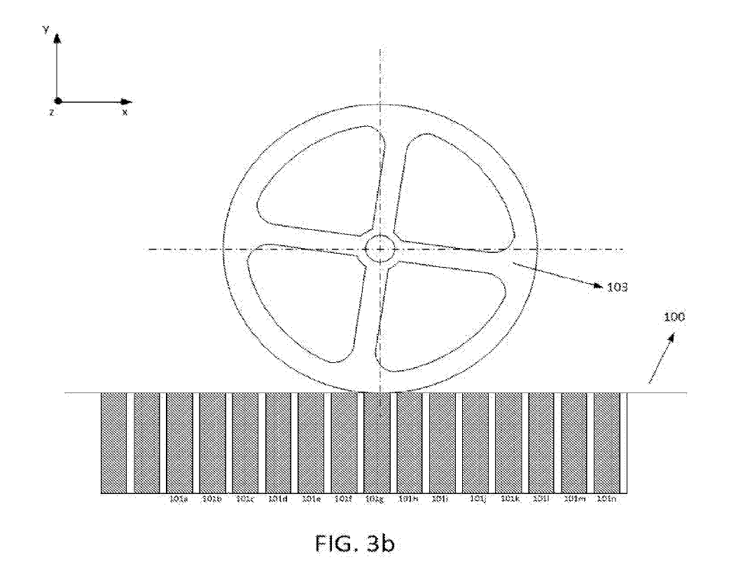

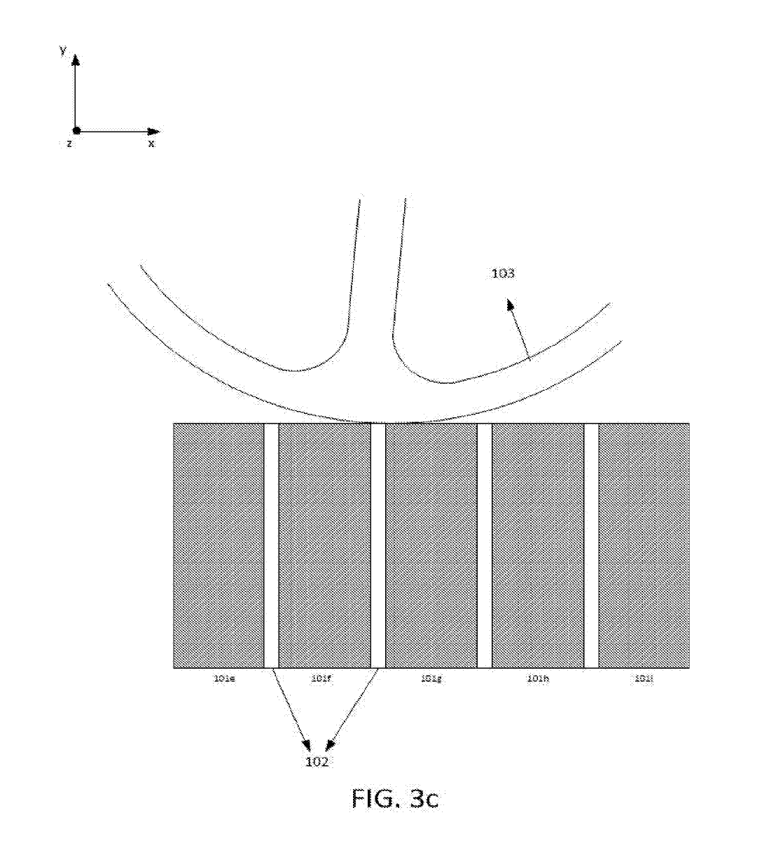

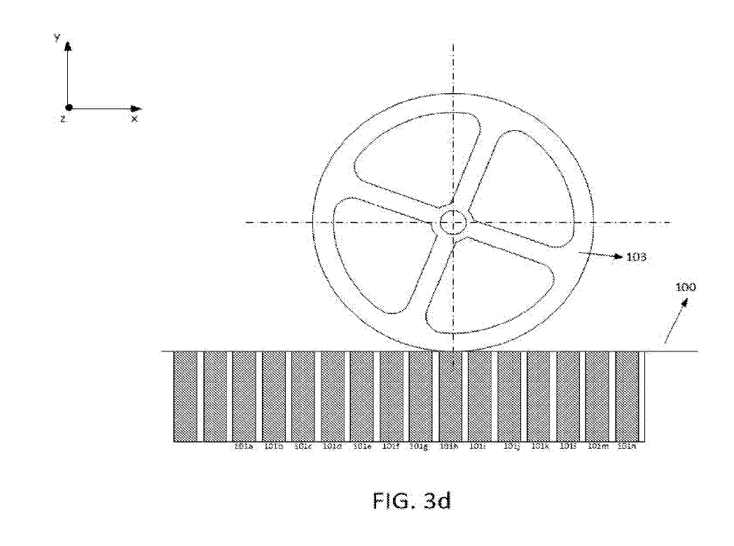

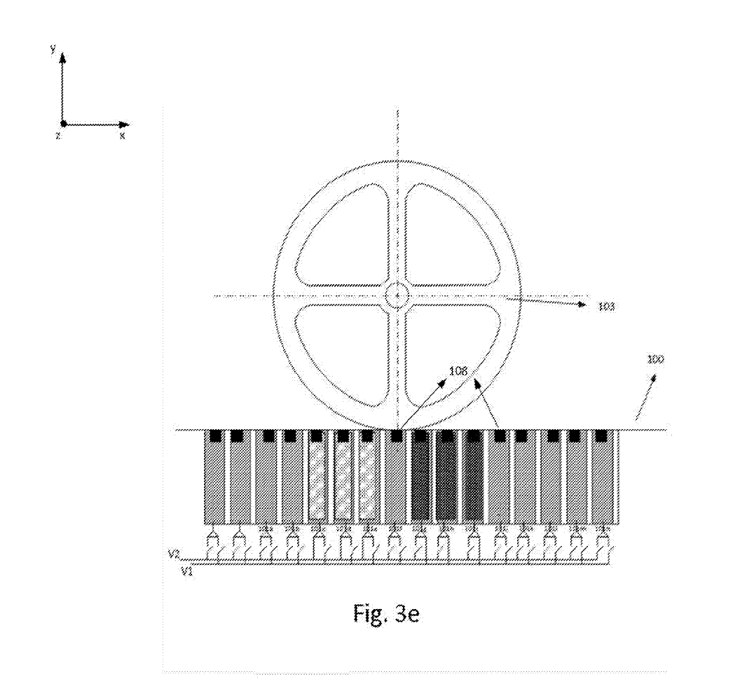

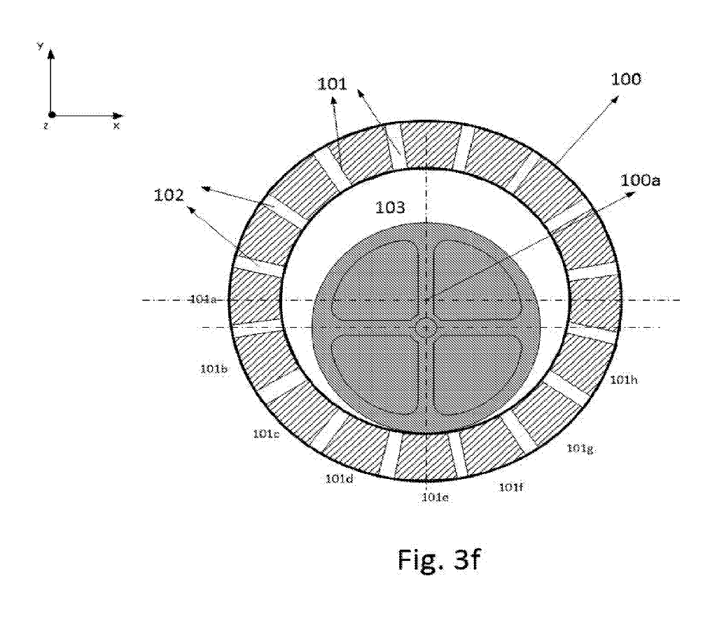

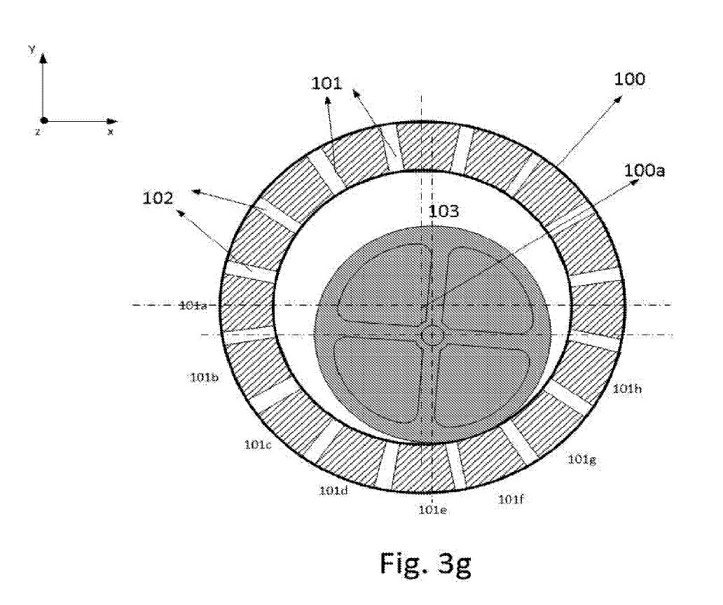

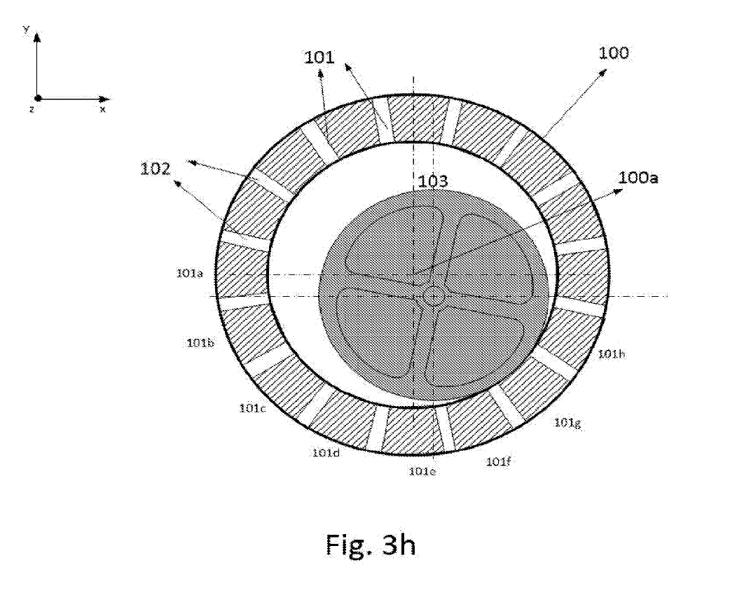

With reference to FIG. 3a (and to FIG. 2 with regard to the interactions among the components of the system), assuming the wheel initially stationary, with all electromagnets deactivated, in order to move in the direction of positive x, the procedure is the following:
Only the electromagnets to the right of the wheel-rail contact (in the direction of positive x) are fed. The possible control unit 106 may use the signals provided by the sensors 105 to detect the electromagnet in contact with the wheel 103. Referring to FIG. 3a, the only electromagnet of the rail in contact with the wheel is 101f. The number of electromagnets to be activated is a function of the total torque to be obtained. In addition, each electromagnet allows to modulate the intensity of the forces through a control of the intensity of current flowing in the coil (the area of the electromagnet, the section of the core, the numbers of turns of the coils, etc... depend on the application). Since the magnetic force of the electromagnets decreases with the square of the distance to the ferromagnetic object, the assessment of how many electromagnets are necessary to switch on will be determined based on specific input parameters supplied by the user (i.e. lower energy consumption to generate the desired torque). For example it is possible to activate the electromagnets, 101g, 101h, 101i, 101j. In the attached figures, the relative sizes of the electromagnets and the other elements only serve the purpose of illustrating clearly the presented variant. For example, in FIG. 3a there are only 8 electromagnets indicated (from 101g to 101n) to subtend approximately ¼ of the circumference of the induced while in real applications there could be several tens of electromagnets subtending the same arc of circumference. The attraction forces developed by these electromagnets give rise to a total torque which gives a clockwise rotation to the wheel 103 and a translation in the direction way of the positive x , until reaching the position in FIG. 3b.
With the wheel 103 as shown in FIG. 3b, the only electromagnet in contact is 101g. This electromagnet is deactivated and, simultaneously, the 101k is activated. As best illustrated in FIG. 3c the deactivation of the electromagnet that is going in contact with the “induced” (101g) can be performed at an earlier stage or at the exact time when the front of the electromagnet surface is in contact with the “induced”. In the figure it is shown the electromagnet 101g when the “induced” 103 comes into contact with it. The electromagnets after 101h and 101i can still be fed. The attraction forces of the electromagnets 101h-101k give rise, as previously, to a total torque which impresses a new rotation in a clockwise direction to the wheel 103 and to a translation in the direction of positive x, until reaching the position in FIG. 3d;
the above procedure is repeated: the electromagnet which is in contact with the wheel, or at an early stage before contact (the 101h) is deactivated and it is activated the first non-powered (the 101l).

The iteration of the steps just described thus produces a rotation of the wheel on the rail in the wanted direction.

In the electromagnets in the contact zone, 101g of FIG. 3b or those immediately following, 101f and 101e of FIG. 3b, or 101h of FIG. 3d or those immediately following, 101g and 101f of FIG. 3d, it may be possible to send currents in the opposite direction, for an appropriate time, to compensate for any magnetic hysteresis that would generate the resistive torques.

The slowing down of a rotating wheel on the rail is carried out in a way similar to the one previously described.

With reference to FIGS. 2 and 3d and assuming that wheel 103 is moving in the direction of positive x: all the coils in the direction of motion of the wheel 103 and indicated with 101i, 101j, 101k, etc. are powered off and, at the same time, by means of the actuators 104, the electromagnets 101g , 101f, 101e are powered on. The possible control unit 106 may use the signals provided by the sensors 105 to detect the electromagnet in contact with the wheel 103. The forces of attraction generated by these electromagnets result in a total torque which opposes the rotation of the wheel 103, slowing it down.

To hold the wheel to the rail it is necessary the control unit powers only the magnets directly in contact with the wheel, by modulating the current intensity and therefore the forces, according to the needs required by the user.

As an alternative to the above defined system and schematically shown in FIG. 1 and FIG. 2, it is possible to define a simplified system where the activation of the electromagnets of the inductor is carried out automatically by pressure switches 108 positioned within the rail/“inducer” and activated by the weight of the vehicle moving along the track/“inducer” (FIG. 3e). This switch automatically turns on (by closing the power supply circuit) the electromagnets next to the contact point of the wheel/“induced” generating the rotation of said wheel.

It is possible to activate with the movement of the vehicle both the electromagnets of the +X direction or those in the −X direction through the pressure switches. For the same reason, the electromagnets must be connected to two different power sources, V1 and V2, depending on whether the motion should be in one direction or in the opposite one.

Referring to FIG. 3e, passing on the switch connects the electromagnets 101g, 101h, 101i to the power supply VI and electromagnets 101c, 101d, 101e to the power supply V2. The control of motion along X+(provided by the operator or automatically) involves the supply by V1 with V2=0. In this condition, in fact, only the electromagnets 101g, 101h, 101i are powered while the electromagnets 101c, 101d, 101e, even if connected to the power supply V2, are not in operation because they are not powered.

The slowing down or moving in the opposite direction occurs for V1=0 and V2≠0. In this condition, the powered electromagnets are 101c, 101d, 101e, and 101g, 101h, 101i, even if connected to V1, will be inactive.

The wheel is locked when V1=V2≠0.

Another embodiment is shown in FIG. 3f, in which the principle of operation remains the same as just described, with the difference that the “inducer” element 100 (fixed) has a circular shape.

The inner wheel 103 is initially supposed stationary and we want to move it counterclockwise around the axis 100a of the “inducer” (and simultaneously in a clockwise direction around its axis of rotation). The electromagnets after the 101e are activated (in a number adequate to what is required by the user, or determined from any control system based on specific input parameters) starting from 101f. The attraction forces of the electromagnets give rise to a torque that rotates the element 103 to the position shown in FIG. 3g.

Again the electromagnet 101f is turned off when it comes into contact with the “induced” and the first inactive electromagnet which follows is fed.

It may also be possible to send to electromagnet 101fa current in the opposite direction for an appropriate time, to compensate for any magnetic hysteresis that would generate resistive torques. The same thing is it possible with all the electromagnets that are turned off. The torque generated by the forces of attraction produces a displacement of the wheel 103 to the position of FIG. 3h.

The iteration of the steps just described thus produces a movement of the wheel 103 along the inner profile of the element 100, around the axis of rotation of the inductor (100a).

The slowing down of the wheel is carried out in a specular way of what described before.

With reference to FIG. 3h and assuming the wheel 103 moving counterclockwise around the axis 100a, all the coils in the direction of motion of the wheel 103 are turned off and, power is supplied to the electromagnets in the other direction starting from 101f. The attractive forces of these electromagnets generate a total torque which opposes the rotation of the wheel 103, slowing it down.

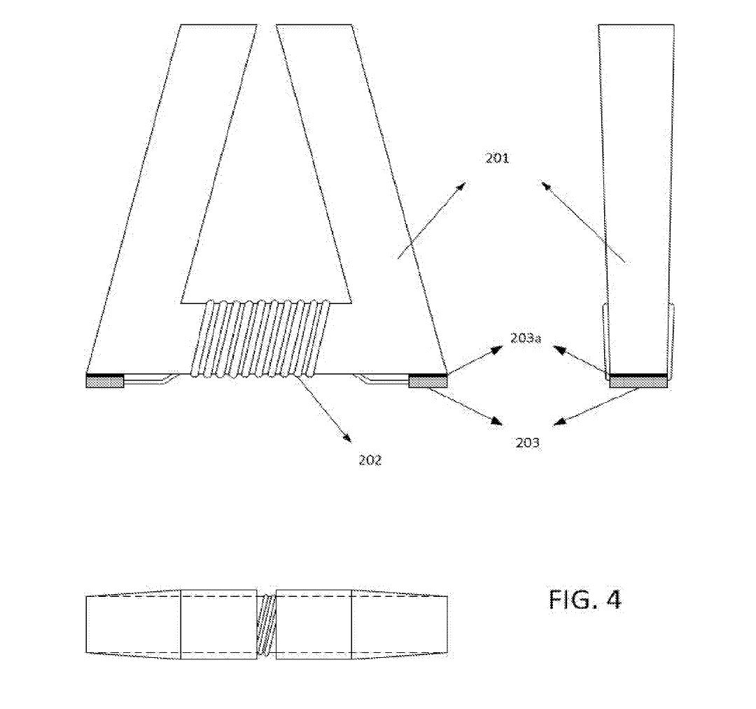

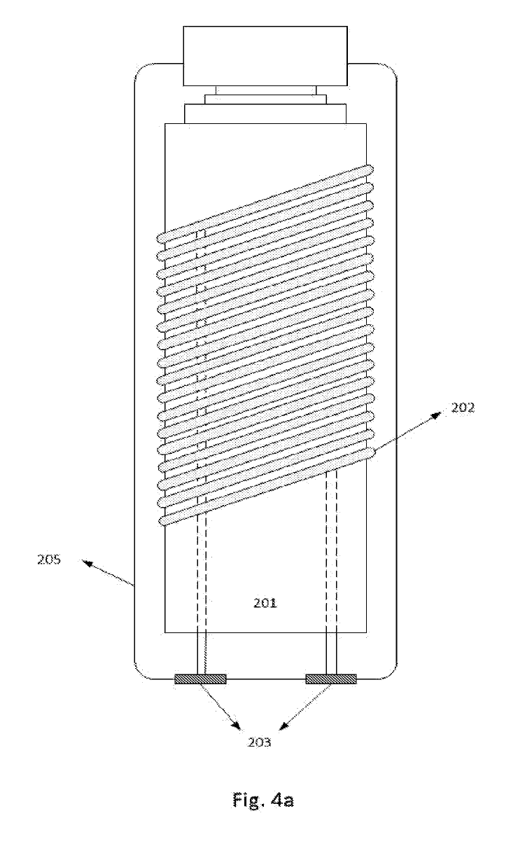

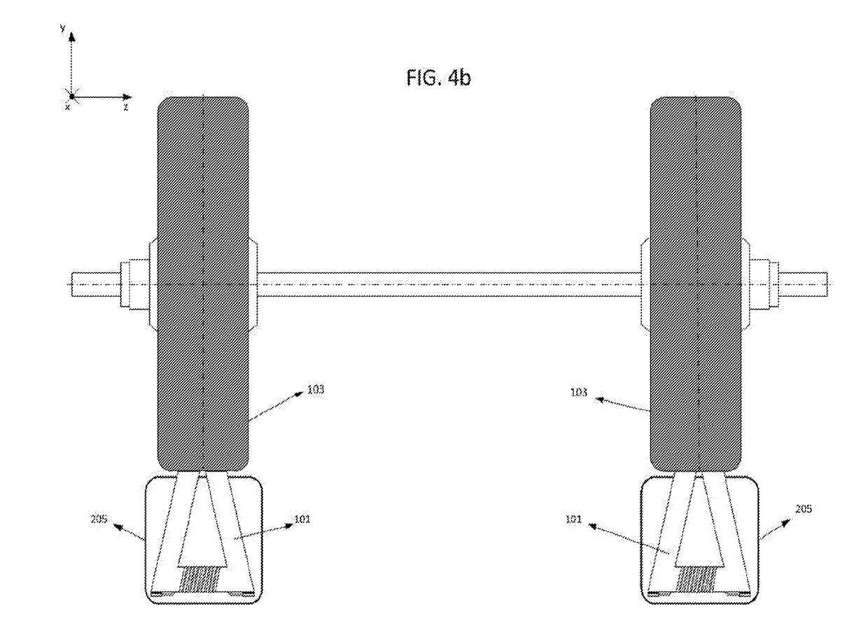

In FIGS. 4 and 4a two possible embodiments for the electromagnets are shown. They highlight in particular the core 201, the coil 202 and the power contacts 203 which can be mobile (brushes) or fixed. Nucleus and contacts, if necessary, can be separated by a layer of insulating material 203a. as well as the electromagnet can be encased in a protective housing 205 which also contributes to the strength and the solidity of the construction. The core may also include various elements such as thin ferromagnetic sheets and insulators.

FIG. 4b shows the section view of two rails (to constitute a binary for the use by appropriate vehicles) comprising the electromagnets 101 presented in FIG. 4 enclosed in a protective casing 205 whose function is also to give more solidity to the overall infrastructure.

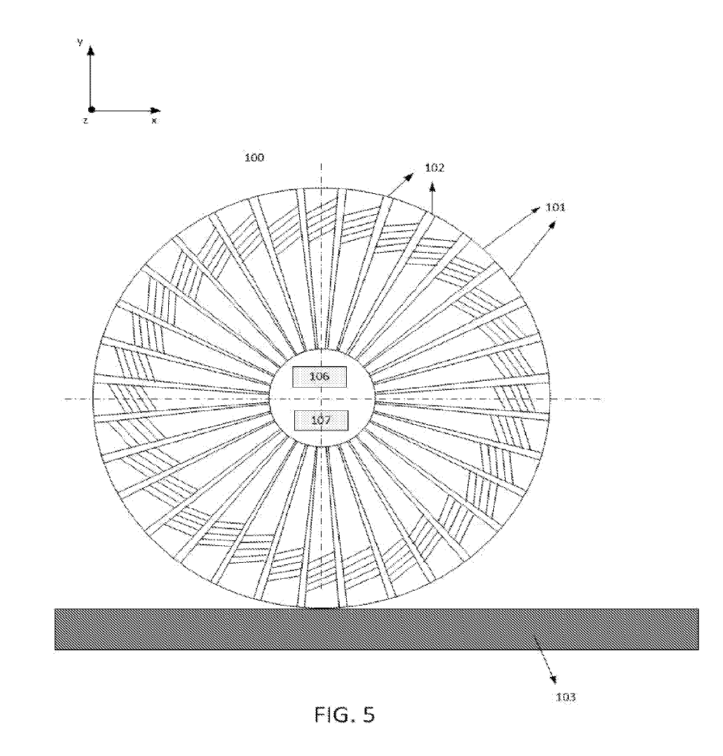

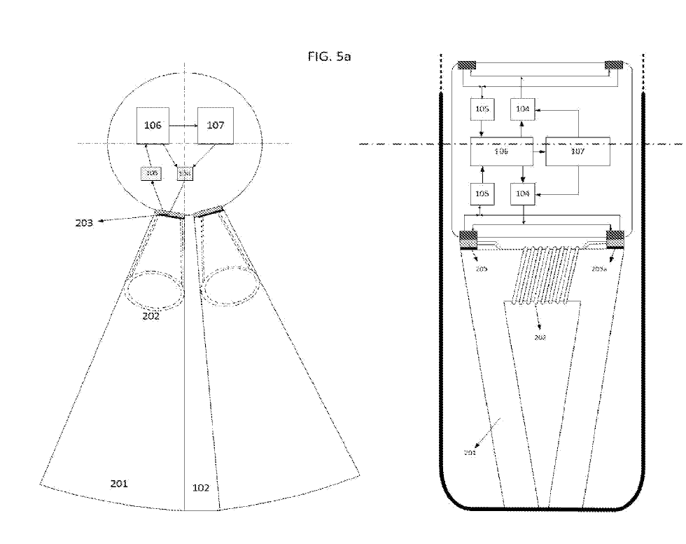

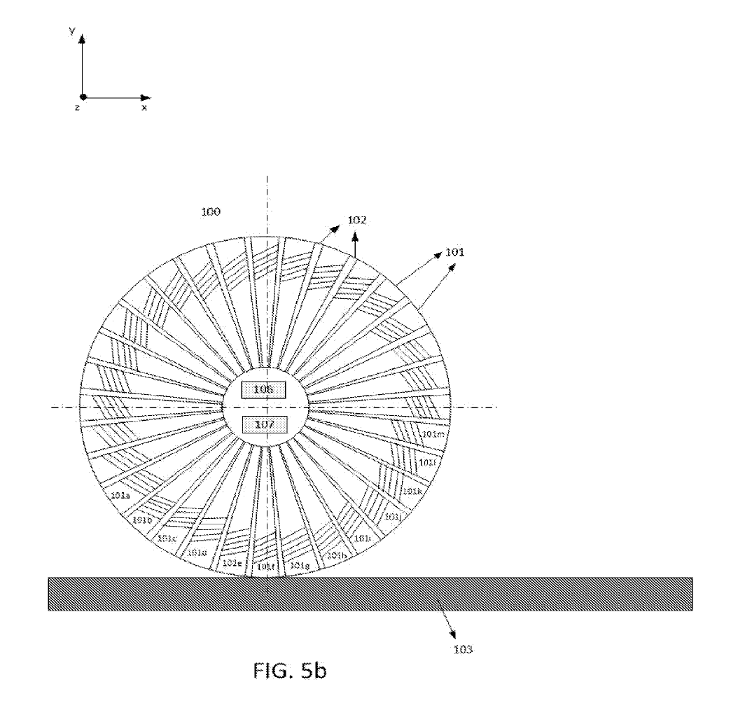

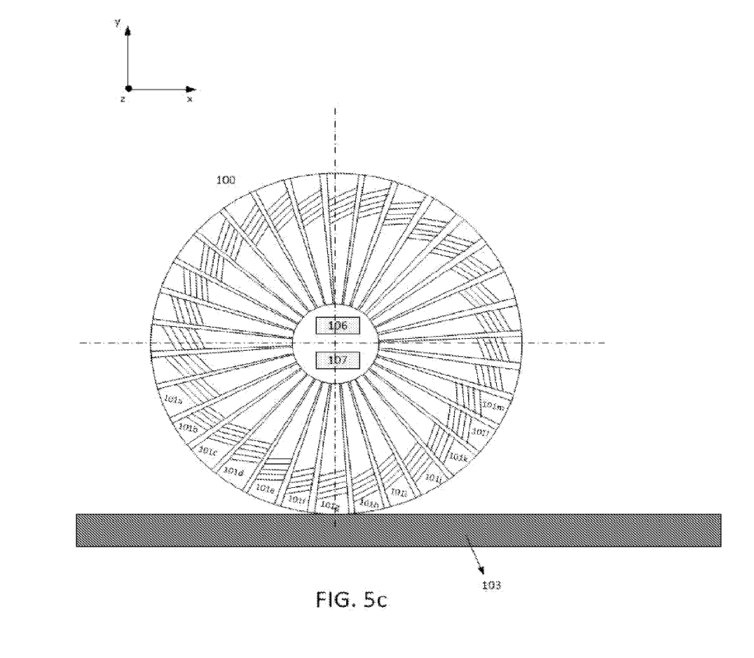

In another embodiment, presented in FIG. 5, the invention comprises:
at least one wheel or rotating element 100 with the function of the “inducer” element which includes electromagnets 101 and non-ferromagnetic elements 102;
a rail (“induced”) 103 that includes ferromagnetic material on which the magnetic fields generated by the “inducer” element act;
a power supply network 107;

Also for this embodiment the electromagnets 101 may assume a configuration similar to that illustrated in FIG. 4b to take advantage of both poles of attraction that are generated. For all embodiments, the electromagnets 101 comprise coils which can be arranged in the most convenient mode according to the applications.

The rotating element or wheel, which can also be part of a vehicle or of another system, is realized through a sequence of electromagnets 101 arranged in radial direction or in general along the circumference, spaced by non-ferromagnetic elements 102 also arranged along radial directions or along the circumference. Each electromagnet is connected to the power supply 107 and may possibly use one or more sensors.

FIG. 5a shows a detail of the configuration, with both lateral view (left) and front view (right), highlighting in particular the electromagnets consisting of a core 201 , coils 202 and electrical contacts 203 and a possible arrangement of the other components, namely the eventual control system 106 , the power supply 107 , the actuators 104 and any sensors 105 . The operating modes are formally identical to that of the previous version.

In particular for the movement of the rotating element, supposing it initially stationary with all the electromagnets not powered, and referring to FIG. 5b, in which the individual electromagnets 101 are each identified by a lowercase letter, using the actuators 104, the electromagnets that are in the same direction of the required motion are turned on (the number of electromagnets to be activated is a function of the total torque to be obtained). For example the electromagnets 101g, 101h, 101i, 101j, 101k are turned on. Since the attractive force of the electromagnets decreases with the square of the distance to the object on which it is applied, the evaluation on how many electromagnets to activate depends on the longitudinal dimensions of them and can be predetermined by the user or by the possibly control system that can also automatically determine this number based on specific input parameters supplied by the user itself.

The attraction forces of the electromagnets against the rail of ferromagnetic material give rise to a total torque which produces the clockwise rotation of the rotating element up to be in the position illustrated in FIG. 5c.

In the new position, 101g is the only electromagnet in contact with the rail: this electromagnet is switched off and simultaneously the 101l is activated (the first non-active electromagnet in the direction of the motion). Similarly to what it is stated above and illustrated in FIG. 3b, in all embodiments of the present invention, deactivation, and possible reverse the current sent to the electromagnet that comes into contact with the induced can occur with a certain advance to counteract the delays of the system and/or to improve the efficiency of the engine.

In the electromagnets in the contact zone, 101g in the FIG. 5c or those immediately following, 101f and 101e of FIG. 5c, it may be possible to send the currents in the opposite direction, for an appropriate time, to compensate for any magnetic hysteresis that would generate resistive torques.

Again, the attractive forces of the active electromagnets give rise to the torque which allows a subsequent rotation of the element to the position of FIG. 5d.

The iteration of the procedure just described, with the cyclic deactivation of the electromagnets that, after the move, will come into contact with the wheel and, in their place, the activation of an equal number of electromagnets in the direction of motion, leads to the advancement of the element, with the speed that can be adjusted by acting on the intensity of the supply current of the windings.

The slowing down of a rotating element is obtained also in perfect analogy to the previous version, activating in a timely manner the electromagnets immediately preceding the point of contact and simultaneously disabling all other, so a total resistive torque that opposes the motion of the rotating element is generated until, eventually, to stop it.

Some other embodiments provide for the more general application of the principle underlying the present invention.

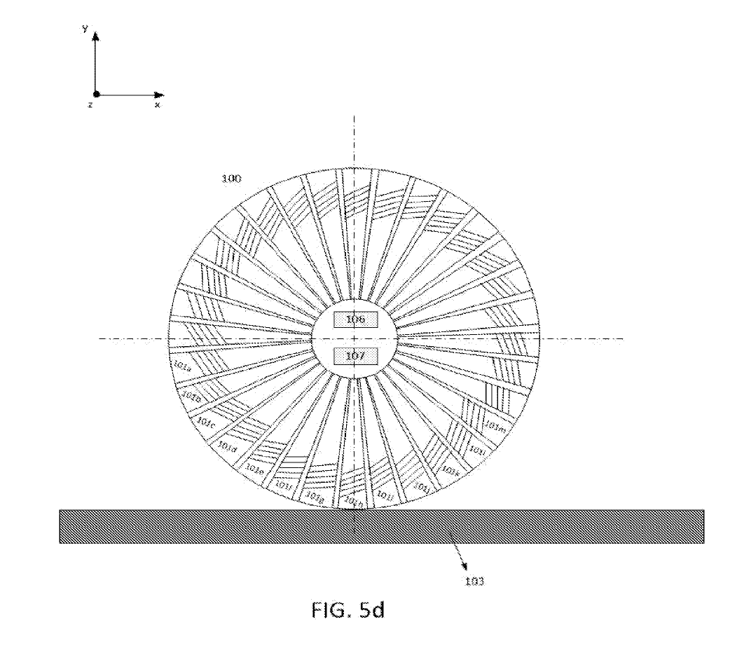

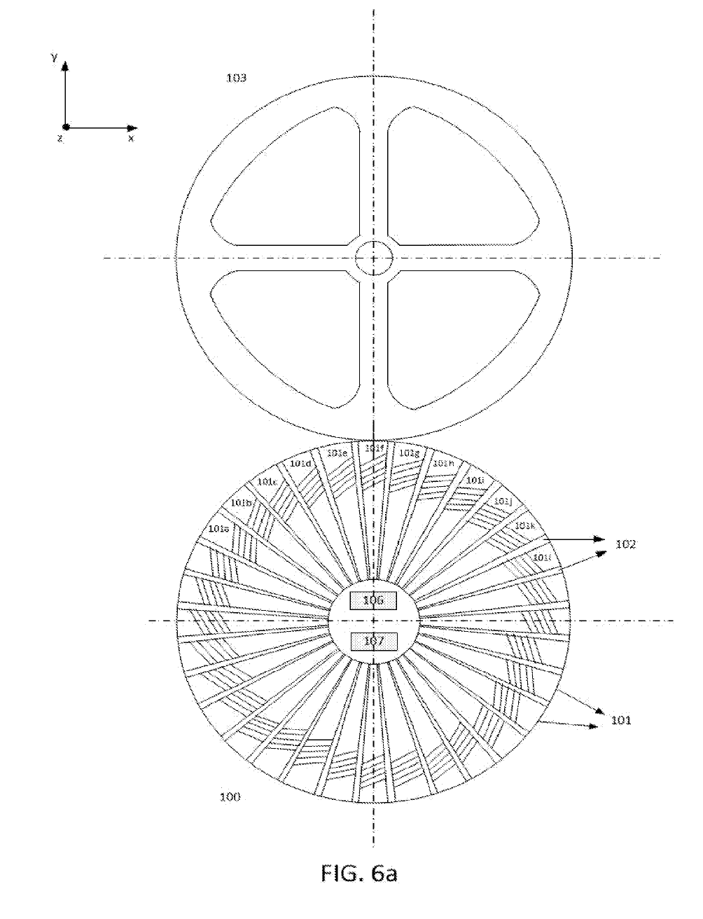

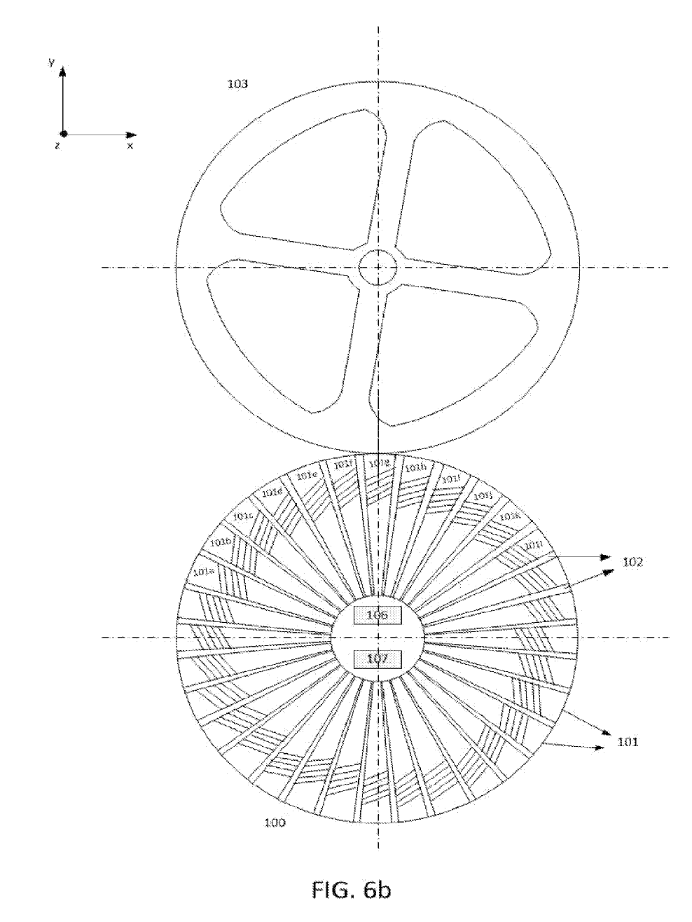

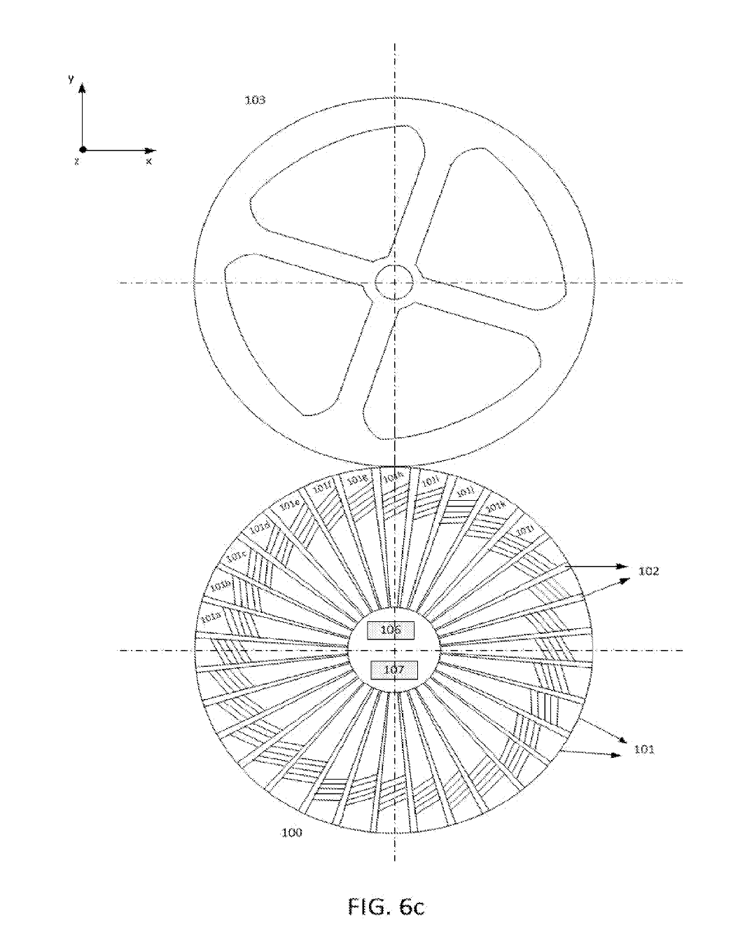

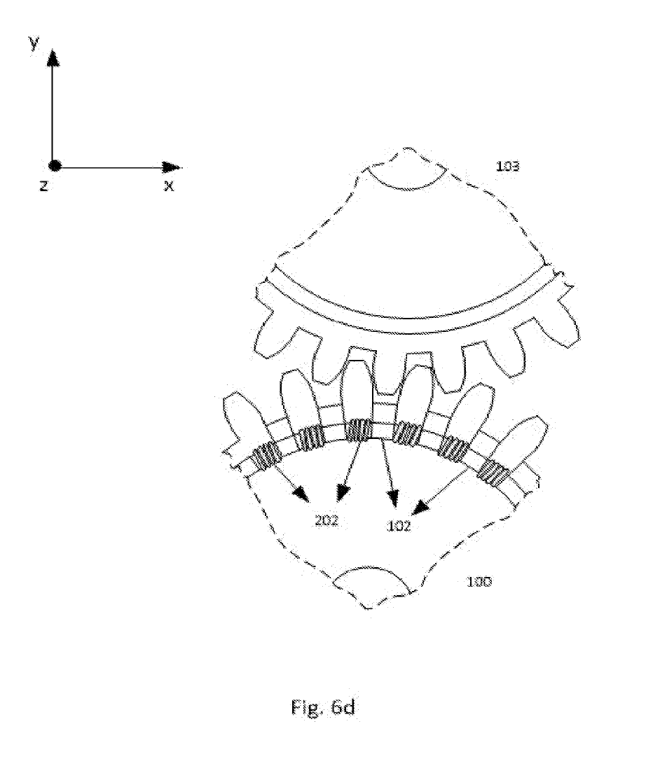

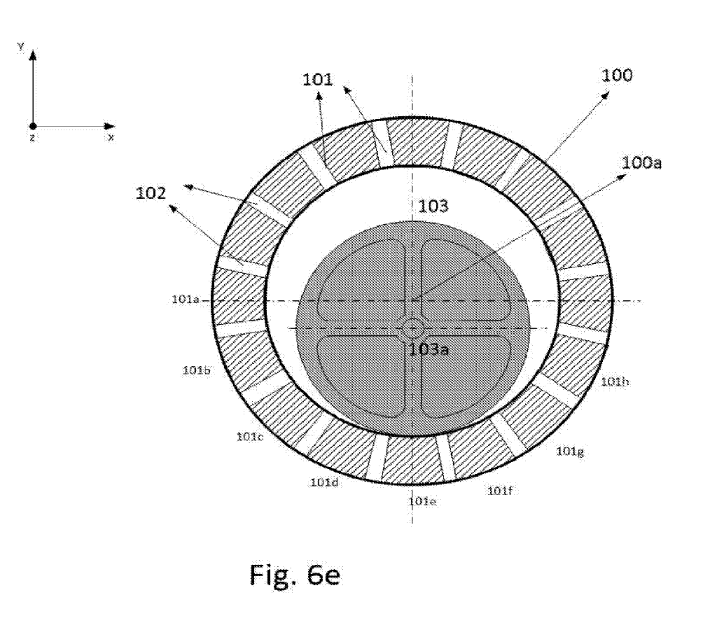

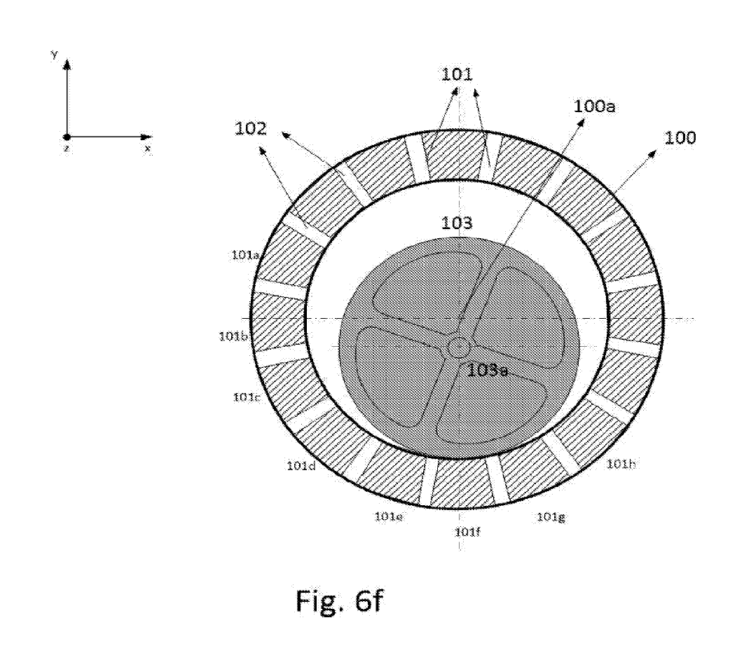

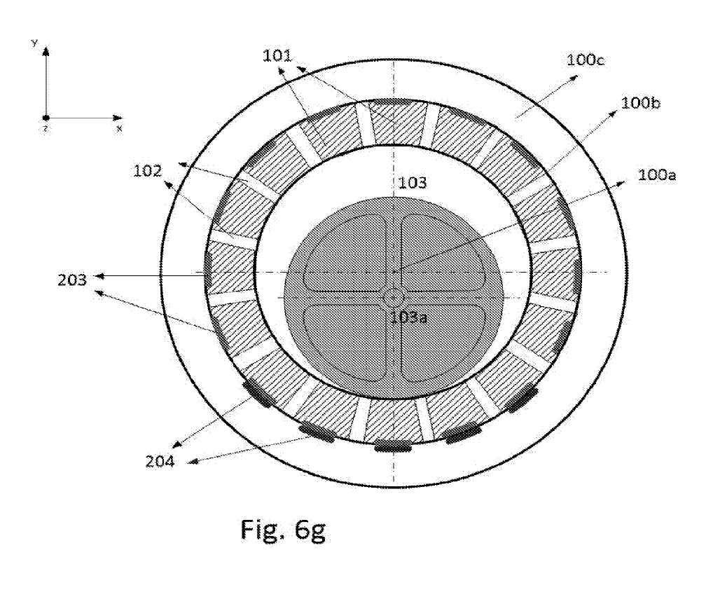

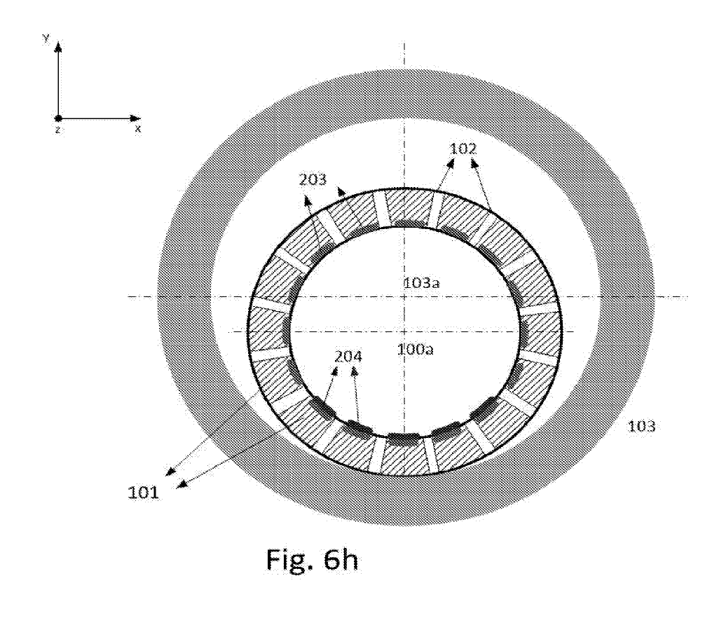

In one of these versions, shown in FIG. 6a, the system comprises:
at least one rotating element 100 with the function of the “inducer” element of the magnetic field that includes electromagnets 101 and non-ferromagnetic elements 102. For more detail about the elements included the FIG. 5a can be used again where are shown the electromagnets comprising core 201, coils 202 and fixed electrical contacts 203, and a possible arrangement of other components, the eventual control system 106, power supply 107, actuators 104, eventual sensors 105 and the non-ferromagnetic elements 102 interposed between the electromagnets;
at least one rotating element 103 (“induced”) that includes ferromagnetic material or may even be totally made of ferromagnetic material in contact with the “inducer” element;
a power supply network;

As an example and in a non-limiting way, the two elements are bonded to an axis of rotation parallel to the z axis, passing through their geometric center and they are free to rotate around it.

The operation is conceptually identical to the previous versions.

Assuming the two elements initially stationary as shown in FIG. 6, the electromagnets subsequent to 101f are turned on, starting with 101g. The number of electromagnets to be activated, as previously, can be determined from any control system based on specific input parameters supplied by the user. In this case, for example, electromagnets 101g, 101h are turned on.

The forces of attraction developed by said electromagnets towards the “induced” generate torques on the “inducer” that make it rotating counterclockwise. The result will be that the system will move to a new position. for example as shown in FIG. 6b. The electromagnet now in contact with the induced is 101g and it is turned off, possibly at an earlier stage to compensate for delays of the system, or as in the cases described above, a current in the reverse direction can be sent, for a convenient amount of time, to compensate for any hysteresis. At the same time the 101i is turned on so as to generate rotational torques and the system reach a new equilibrium situation, as in FIG. 6c.

In a similar way, it is possible to slow down the motion. Assuming the system is in the situation illustrated in FIG. 6c. The electromagnets after 101h are turned off while the ones before the 101h are turned on starting with 101g. The effect is to obtain braking torques. The iteration of the just described steps involves the gradual slowing down of the rotation of the wheels and possibly to stop them.

As previously described, in preferred embodiments, wheels, rotating elements and rails can have the shape and profile of the types normally used in the field of transport and industrial (conical, straight, s-shaped, toothed, etc.).

By way of example and without limitation, in FIG. 6d is shown the detail of a configuration in which the inductor 100 and armature 103 are gear wheels of the type commonly in use.

In particular, the windings of the electromagnets 202 and the ferromagnetic elements 102 are highlighted.

In another embodiment, the system assumes the configuration of FIGS. 6e-6f: in this embodiment the “inducer” element 100 and the “induced” 103 are not concentric but have different axes of rotation respectively indicated with 100a and 103a and the air gap that separates them is not constant but varies from a minimum distance (which can also be zero, as in the case in the figure) to a maximum distance found in the diametrically opposite point.

The operation is not unlike what was seen previously, obtaining the effect that both components rotate around the respective axes of rotation.

A variant of this version, which constitutes an autonomous embodiment, is shown in FIG. 6g.

The “induced”, for example depicted as a wheel, comprises ferromagnetic material and is free to rotate around its axis of symmetry 103a, parallel to the z axis. The “inducer” 100 includes an inner rotating part 100b and an outer fixed part 100c. The inner part rotates around the axis passing through the geometric center 100a. In this inner part are housed the electromagnets 101 spaced with non-ferromagnetic material 102. Each electromagnet is equipped with specific contacts (or brushes) 203 that allow it to be powered from the main power supply (not shown in the figure). The outer part has a fixed number of power contacts (or brushes) 204, in a number smaller than that of the electromagnets.

This solution allows to activate, from time to time, only the electromagnets able to provide a significant contribution to the movement or a number of electromagnets predetermined by the user, leaving the remaining unfed. Therefore is it possible to reduce in a significant manner the complexity of the connections and, more in general, of the components.

A further variant foresees the “inducer” as the inner wheel and the “induced” as the outer wheel. Also for this configuration the “inducer” can include a fixed inner part and a rotating outer part as illustrated in FIG. 6h. Except for the different arrangement of “inducer” and “induced” there are no other differences. The outer part of the “inducer” is free to rotate around the axis of rotation 100a and houses the electromagnets 101 with the respective contacts 203 for the power supply while the inner fixed part has the contacts 204 in a number equal to the number of electromagnets which can be activated simultaneously.

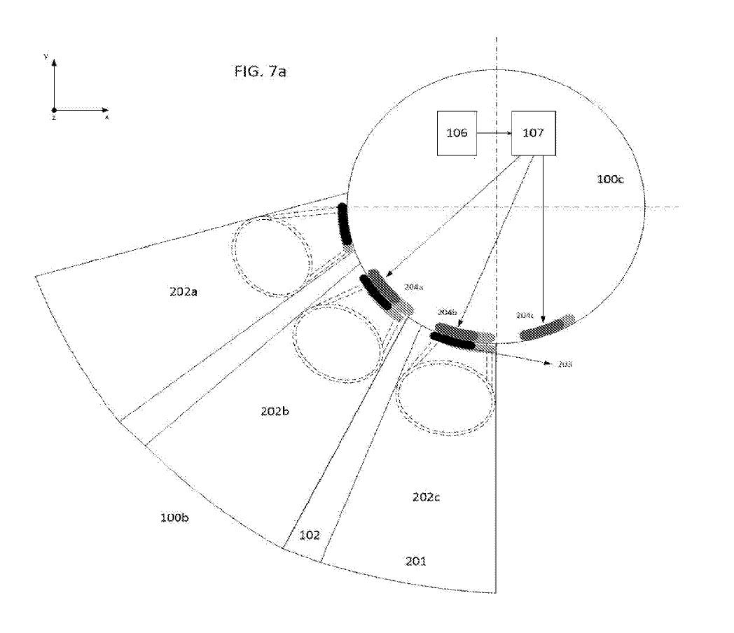

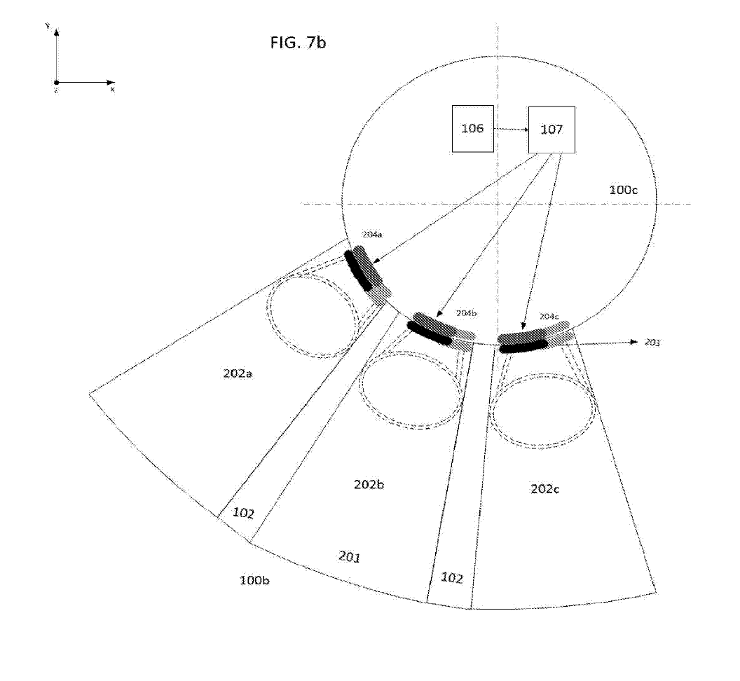

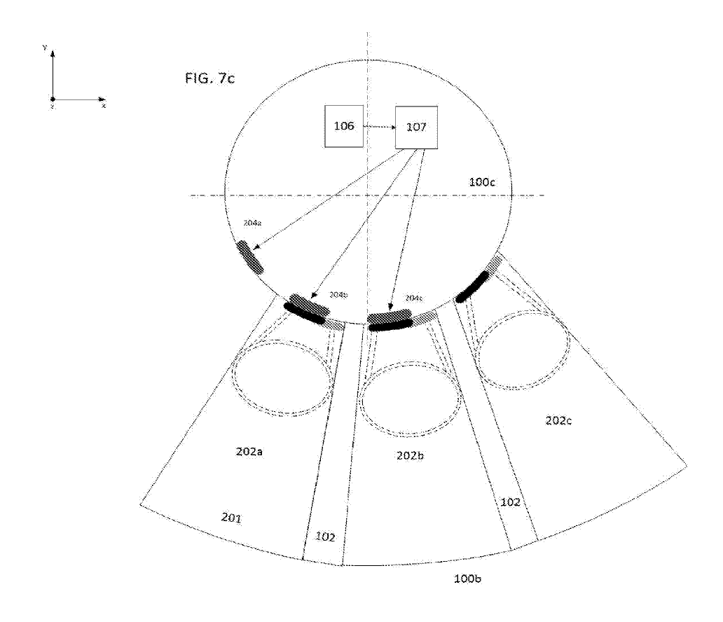

In general for all configurations that include a rotating “inducer” element, it is possible for said element having the configurations shown in FIGS. 6g and 6h. In FIG. 7a a detail is shown. The rotating element 100 includes a rotating outer part 100a with the form of a circular ring and a fixed internal part 100b. All the coils of the electromagnets 202 end with the contacts 203. In the fixed part 100b are contained a number of contacts 204 (in turn connected to any component of complement such as actuators 104 and/or any sensors 105) less than the total number of all the electromagnets, in function of the maximum number of electromagnets which may be simultaneously active.

This embodiment finds its justification in the fact that at any time only a part of the electromagnets is effectively active, while the remaining are unused. Therefore it can possible to significantly reduce the complexity of the connections and, more generally, of the components. With reference to FIG. 7a, only the coils 202b and 202c are connected to the power supply 107, through the contacts 204a and 204b, while the coil 202a is off. Assuming that the element is rotating counterclockwise, in the next step. the situation will be as shown in FIG. 7b, where the coils 202a and 202b are turned on (respectively by the contacts 204a and 204b), while, through the contact 204c, it is possible to send a current with the appropriate direction on the coil 205c to compensate for the magnetic hysteresis which may be present. Progressing the motion, the next configuration assumed by the system is the one in FIG. 7c, where the coil 202c no longer participates in the operation because it is no more connected to the contacts, while the contact 202b is connected to 205c through which any residual magnetization is reduced.

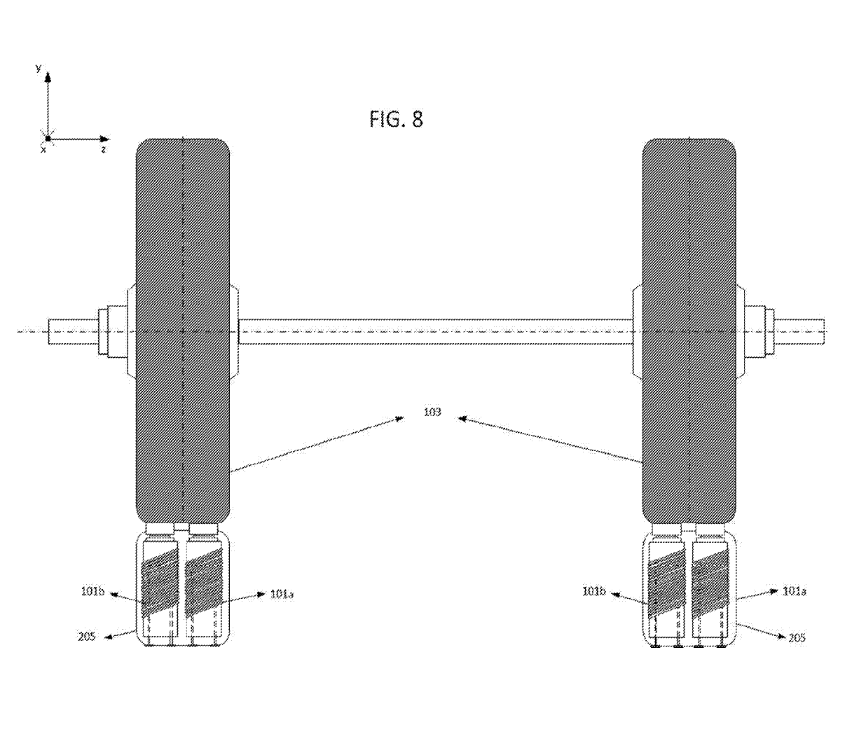

In all the presented embodiments is possible to realize the “inducer” element to an alternative form that provides sequences of multiple electromagnets side by side as depicted in FIG. 8. As an example, it is shown a section view of the same rail of FIG. 1 but realized with couples of electromagnets. It may be, as in the figure, the infrastructure for a track and the electromagnets 101 are spaced by layers of non-ferromagnetic material (not shown in the drawing) and can be enclosed by a protective case 205 that also helps to increase the solidity of the structure. The advantage of this implementation lies in the fact that it is possible to put the electromagnets with a certain inclination with respect to the vertical and it is possible to modulate along the z direction the overall forces of attraction acting on the wheels, since the electromagnets are individually manageable.

For all the presented embodiments it is possible to make a different version of the “induced” element comprising in its structure permanent magnets in order to improve system performance.

These permanent magnets contribute to the functioning of the system in two ways
the permanent magnets situated before the contact area (or minimum distance between the “inducer” and “induced”) contribute with their forces of attraction to the torque originated by the active electromagnets of the “inducer” element;
at the same time, activating with an opposite current the electromagnets after the contact area or minimum distance between the “inducer” and “induced”) it is possible to take advantage of the repulsive forces that are created between magnets of opposite polarity to generate a further torque which is added to the previous.

For simplicity of exposition we will refer to the first embodiment, taking into account that the application to the other embodiments is to be considered a simple extension of this, without the need to introduce other innovative aspects.

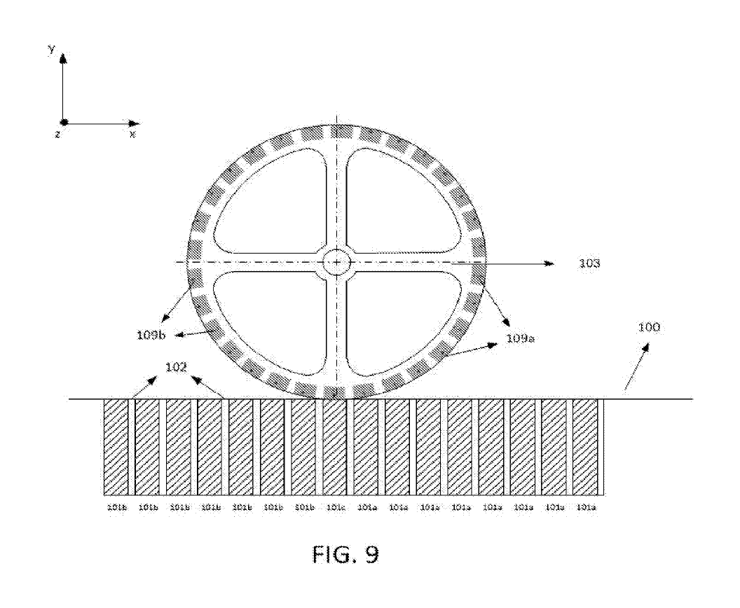

FIG. 9 shows this alternative implementation: the “induced”, here in the shape of a wheel, is equipped with a series of permanent magnets 109 distributed on its outline. The polarity of the permanent magnets shown in the figure is only descriptive. Regarding the operation of the system, a permanent magnet is a purely passive component, but it is possible to take advantage of its features as described below. Assuming the wheel initially stationary and wanting to generate a rotation in the direction of positive x:
the electromagnets 101a are activated to produce the forces of magnetic attraction towards the wheel 103. These forces are increased by those produced autonomously by the permanent magnets 110a placed with the correct polarity and the result is that of increasing the total torque that moves the wheel;
the electromagnets 101b are fed with a current whose direction is such as to generate a magnetic field of polarity equal to the one generated by the permanent magnets in that direction. The repulsive magnetic forces that are to be determined between electromagnets and permanent magnets give rise in turn to an additional torque whose effects are added to the previous one.

Therefore, the introduction of the permanent magnets allows to:
obtain the same torque with less energy;
or, alternatively, a greater torque with the same provided energy.

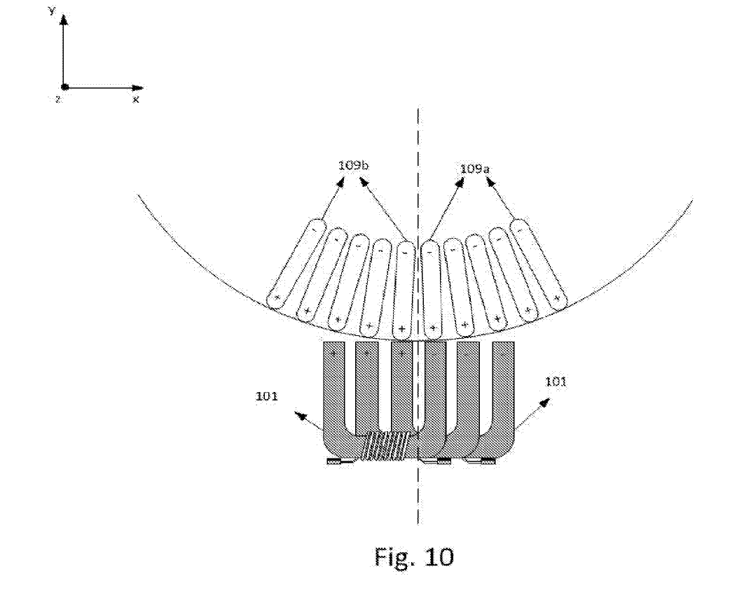

FIG. 10 shows a variant of the solution just presented, using the classic “U-shaped” electromagnets 101, in addition to permanent magnets 109a and 109b present in the wheel. The advantage is to use both the magnetic fields that are generated at the two ends of any electromagnet. In particular, the figure focuses on the area of contact between wheel and electromagnets to better highlight the couplings between the polarities: in fact in the direction of motion (the one of positive x) there are magnetic fields of opposite polarity, “positive-negative”, which generate attractive forces, while at the opposite face each other magnetic fields of equal polarity, “positive-positive”, generating repulsive forces that help the rotation in the required direction.

To complete this description, there will be shown two other embodiments resulting from changes to other forms already presented. These changes do not introduce new elements, neither in the operation nor in terms of design.

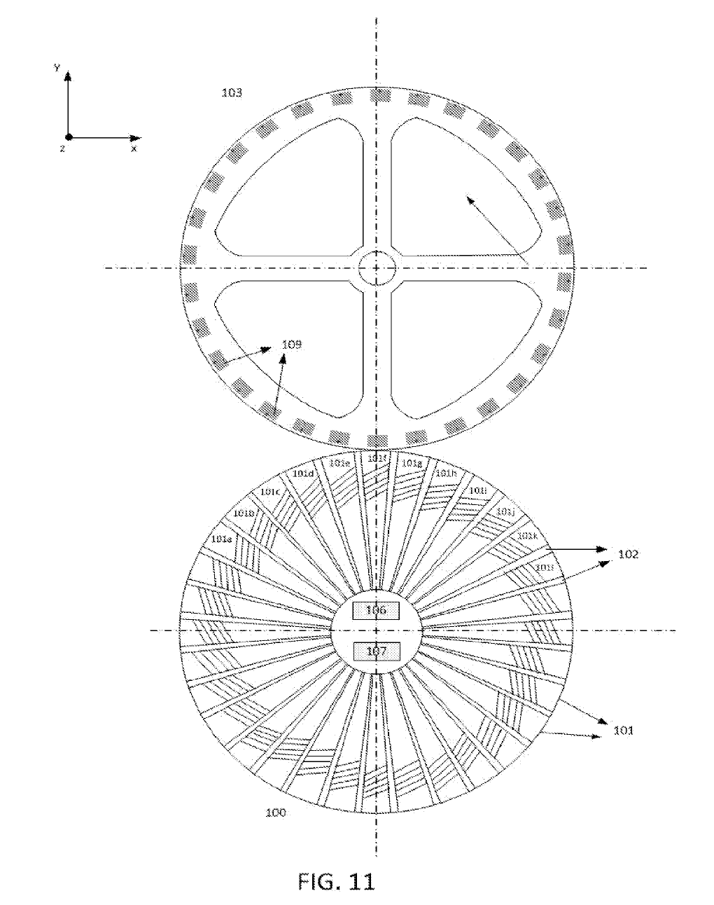

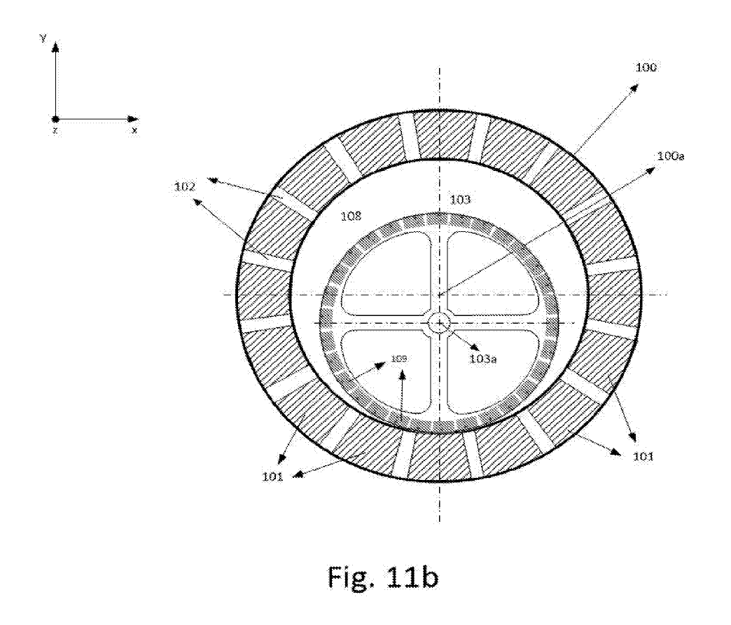

In FIG. 11 is shown the embodiment already seen in FIGS. 6a-6c, in which, however, the “induced” subsystem 103 comprises permanent magnets, with the consequent benefits already mentioned above, of increasing the overall drive torque.

In FIG. 11b is shown the embodiment in which the “induced” subsystem comprises permanent magnets, with the consequent effects, already exposed, to increase the overall drive torque.

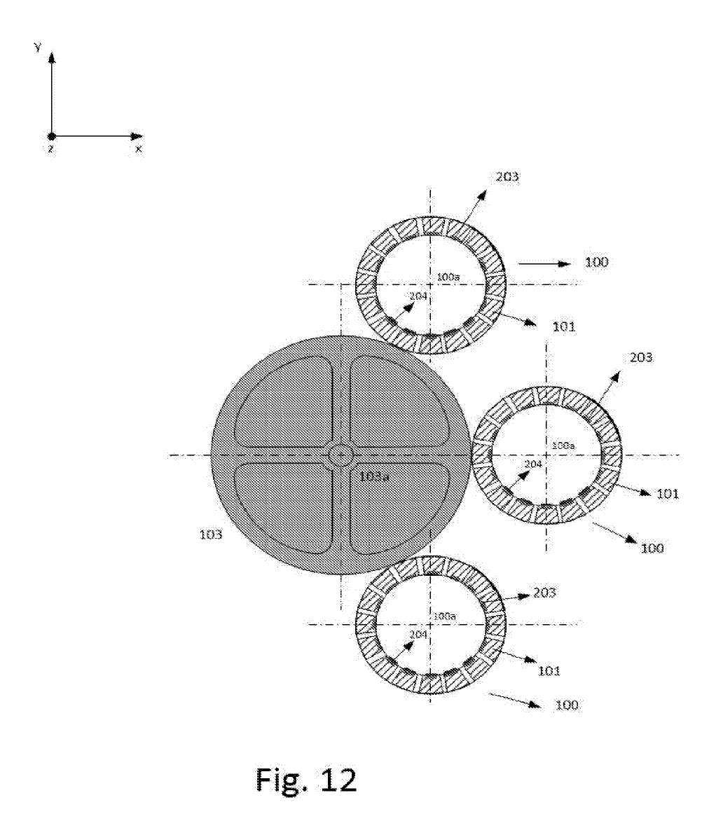

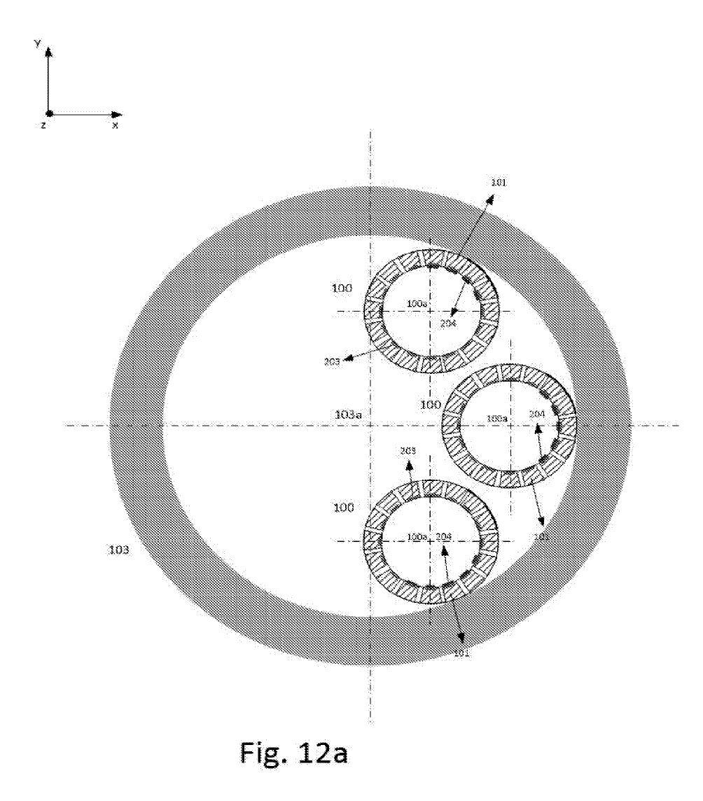

In FIGS. 12 and 12a, which differ only in the arrangement of the components, are shown two special configurations with more “inducers” which act on a single “induced”, which may comprise permanent magnets. This configuration allows to develop higher driving or braking torques at the same time. Considering that the more efficient electromagnets are those that are closer to the contact point or at the minimum distance from the “induced”, the advantage of this configuration is that of having more electromagnets in such a favorable condition and therefore it is possible to obtain higher conversion efficiencies of electrical energy into mechanical energy.

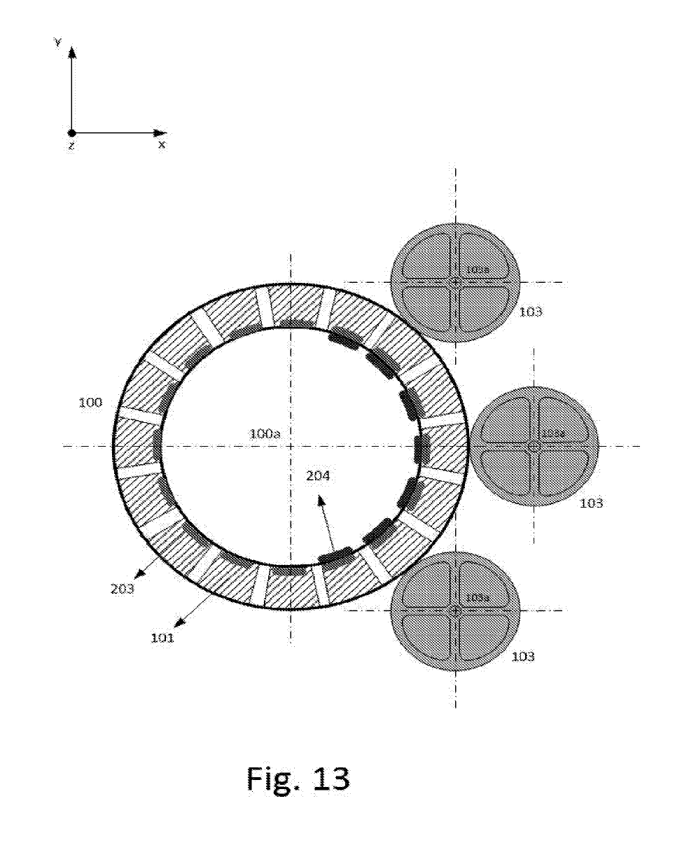

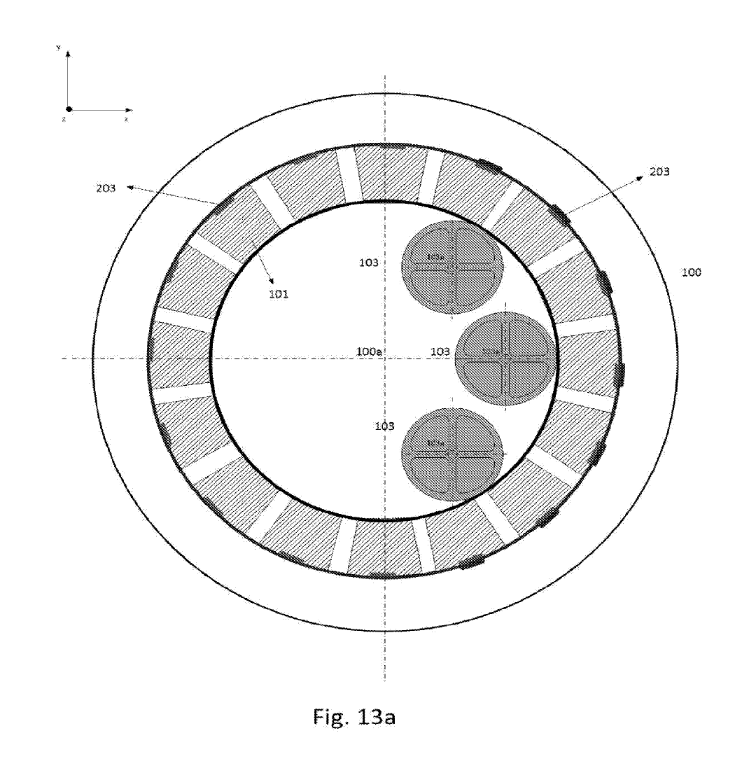

In FIGS. 13 and 13a, which are different only in the arrangement of components, are shown two configurations with a single “inducer” and several “induced”. In this case the result is an optimization of the use of the electromagnets.

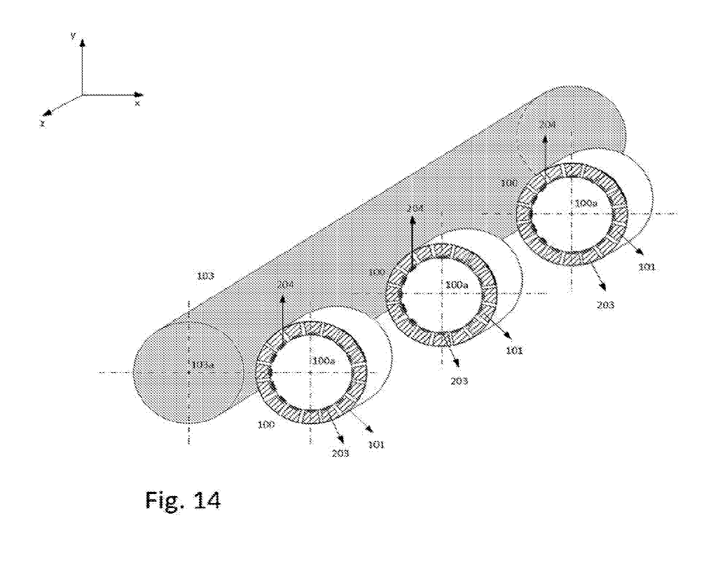

In FIG. 14 is shown a configuration with several “inducers” and a single “induced”, with a shape different from the other ones described so far, as an example of the modularity of the present invention which may take different forms depending on the type of problems to be addressed.

Also for all the variants shown in FIGS. 11, 12, 13 and 14 the “induced” subsystem, or subsystems, can include permanent magnets.

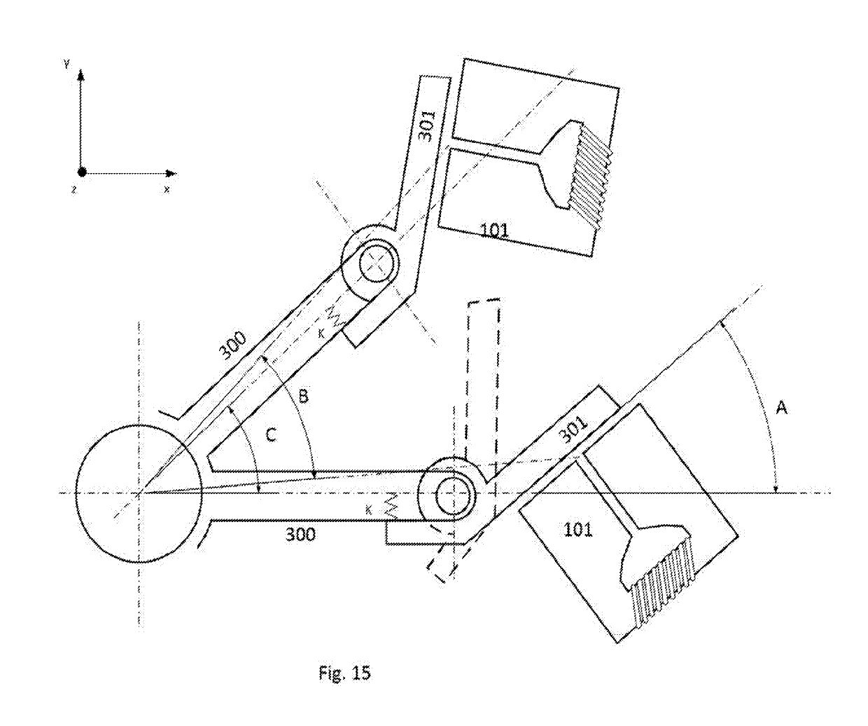

In FIG. 15 is shown a configuration where the rotating elements of the “induced” comprise components that can rotate in their turn around them. This allows to build engines where there are more electromagnets which act simultaneously in the area of contact or of closest distance between “induced” and “inducer”, and to be able to vary both the magnetic forces and the arc of rotation along which these forces act, in order to realize the engine that best meets the desired characteristics.

In a possible version of this configuration, the component 301 can partially rotate around axes parallel to the z axis shown in FIG. 15. When the attractive force acts on it, a rotating torque brings it to the stop position in the direction of clockwise rotations and this allows the transfer of a torque of clockwise rotation on the rotating element 300. In the moment that the component 301 comes in contact with the electromagnet 101, or a moment before, the electromagnet is deactivated and the component 301 can partially rotate around the z axis anticlockwise to oppose less resistance to the passage and reduce the resistant torque to clockwise rotation of the “induced”. There may also be a spring k to return the component 301 in the stop position indicated.

In FIG. 15 is also indicated an angle A, with respect to the local radial, which can vary depending on the applications in order to provide the best combination of magnetic forces and rotation arc along which they act.

The different electromagnets may be distributed along the circumference of the “inducer” subsystem separated from each other by an angle B which is slightly different from the angle of separation C between the rotating elements of the “induced”, or a multiple of it, so as to give a better continuity to the driving or braking torque transmitted to the “induced”.

The components of the “induced”, instead of rotating around axes parallel to z axis shown in the figure, may alternatively rotate around axes parallel to the local radial.

1. Magnetic engine for the transformation of electrical energy into mechanical energy in which:
at least one “inducer” subsystem (100), which comprises a sequence of electromagnets (101), detached from each other, separated by free space or non-ferromagnetic elements (102) and powered also individually, is included;
one or more “induced” subsystems (103), also composed of ferromagnetic material, are included;
each pair consisting of a “induced” subsystem (103) and a “inducer” subsystem (100) performs a movement in which said “induced” (103) and “inducer” (100) subsystems rotate relative to one another around at least an axis of rotation;
at least one source of power supply, able to provide electric current to each electromagnet (101) and to generate magnetic fields nearby said electromagnets (101) when powered, is included;
at least one control mechanism or subsystem (106), which is able to selectively manage the powering of some electromagnets (101) of said “inducer” subsystem (100), is included;
and said magnetic engine is characterized in that, in each pair consisting of a “induced” subsystem (103) and a “inducer” subsystem (100):
the relative movement between said “induced” subsystem (103) and said “inducer” subsystem (100) is also generated by the magnetic attraction force acting between said electromagnets (101) of said “inducer” subsystem (100) and said ferromagnetic material which said “induced” subsystem (103) is composed of;
said control mechanism or subsystem (106) selectively provides power to said electromagnets (101) as a function of the position of said “induced” subsystem (103) so that it generates a magnetic field which is variable in space and in time and which vanishes or changes direction in the zones and in the time intervals of maximum approach or contact between said “inducer” subsystem (100) and said “induced” subsystem (103);
the relative motion of said “induced” subsystem (103) with respect to said “inducer” subsystem (100) does not determine, in the zones and in the time intervals of maximum approach or contact between said two subsystems “induced” and “inducer” (100 and 103), a configuration in which parts of ferromagnetic material, which said “induced” subsystem (103) is composed of, are geometrically placed between the positive and the negative polarity of any single powered electromagnet (101) comprised in said “inducer” subsystem (100);
during the relative motion of said “induced” subsystem (103) with respect to said “inducer” subsystem (100) the variations of the air gap in each powered electromagnet (101) are characterized in that they are both simultaneously increasing or decreasing in their components along the directions orthogonal to the faces corresponding to the polar terminations, positive and negative, of said powered electromagnets (101) composing said “inducer” subsystem (100).

2. Magnetic engine according to claim 1, wherein:
said electromagnets (101) are arranged along a trait of rail that assume a configuration which may be circular, straight or curved,
said “induced” subsystem (103) is arranged so as to rotate on said trait of rail around an axis of rotation;
the faces corresponding to the positive and negative polar terminations of said electromagnets (101), composing said “inducer” subsystem (100) lie in a surface portion, are both oriented towards of said “induced” subsystem (103) and all the perpendiculars outgoing from said faces of said polar terminations of said electromagnets (101), while they are powered, not ever intersect, during the relative motion between the “inducer” and “inducted” subsystem, the axis of rotation of said “induced” subsystem (103).

3. Magnetic engine according to claim 1, wherein:
said electromagnets (101) are arranged so as to rotate around an axis of rotation,
said “induced” subsystem (103) is arranged along a trait of rail that assume a configuration which may be circular, straight or curved, on which said electromagnets (101) of said “inducer” subsystem (100) can rotate,
the faces corresponding to the positive and negative polar terminations of said electromagnets (101), composing said “inducer” subsystem (100) lie in a surface portion, are both oriented towards of said “induced” subsystem (103) and all the perpendiculars outgoing from said faces of said polar terminations of said electromagnets (101), while they are powered, during the relative motion between the “inducer” and “inducted” subsystem, not ever intersect the surface of said “induced” subsystem (103) perpendicularly.

4. Magnetic engine according to claim 1, wherein:
said “induced” subsystem (103) is also composed of permanent magnets, and it is arranged so as to rotate around an axis of rotation,
said electromagnets (101) are positioned so that the faces corresponding to the positive and negative polar terminations of each electromagnet (101), which composes said “inducer” subsystem (100), result arranged in a row transverse to the planes which contain said axis of rotation of said “induced” subsystem (103) and which pass between the polar terminations of said electromagnets (101) while they are powered,
the relative movement between said “induced” subsystem (103) and said “inducer” subsystem (100) is generated by both the attraction and the repulsion magnetic force acting between said permanent magnets of which said “induced” subsystem (103) is composed of, and said electromagnets (101) of said “inducer” subsystem (100), when they are powered,
the faces corresponding to the positive and negative polar terminations of said electromagnets (101), composing said “inducer” subsystem (100) lie in a surface portion. are both oriented towards of said “induced” subsystem (103) and all the perpendiculars outgoing from said faces of said polar terminations of said electromagnets (101), while they are powered, not ever intersect, during the relative motion between the “inducer” and “induced” subsystem, the axis of rotation of said “induced” subsystem (103).

5. Magnetic engine according to claim 3, wherein said “inducer” subsystem (100) includes a fixed part comprising the connections with the electric power source and a movable part too, which is free to rotate around an axis of rotation, and said movable part comprises said electromagnets (101) and said non-ferromagnetic elements (102).

6. Magnetic engine according one of the preceding claims, wherein said “inducer” subsystem (100) includes two or more electromagnets (101) side by side in the direction transverse to the direction of relative motion of said subsystem “induced” (103) with respect to said “inducer” subsystem (100), and these electromagnets are interspersed with one or more elements of non-ferromagnetic material.

7. Magnetic engine according one of the preceding claims, in which are also comprised:
one or more sensors (105),
one or more command devices (104), each of said command devices (104) connected to one or more electromagnets (101) of said “inducer” subsystem (100),
a control system (106) which controls said control devices (104) as a function of information received from said sensors (105).

8. Magnetic engine according the preceding claims wherein at least one interface between said control system (106) and said sensors (105) or said control devices (104) is of the wireless type.

9. Magnetic engine according to claim 1, wherein said “induced” subsystem (103) is arranged so as to rotate around an axis of rotation and is also made of moving parts (300 and 301) non-rigidly bound between them by means of rotating constraints that allow to give to said “induced” subsystem (103) a variable conformation as a function of its position with respect to the elements of said “inducer” subsystem (100).

10. Magnetic engine according the preceding claims which comprises spring elements (k) which, in the home position, maintain at an “end of stroke” the mutual positioning of said moving parts (300 and 301) of said “induced” subsystem (103), and allow the mutual rotation of said moving parts (300 and 301) towards the other “end of stroke” when said “induced” subsystem (103), during its overall motion, touches elements of said “inducer” subsystem (103), and said spring elements (k) exert a restoring force towards the home position as soon as there are no more obstacles that determine the mutual rotation of said moving parts (300 and 301).

11. A method for providing mechanical work in generic propulsion systems via a magnetic engine made according to any of preceding claims, that directly exploits, in a way controlled in space and time, the attraction magnetic forces between said electromagnets (101) and said ferromagnetic material which said “induced” subsystem (103) is composed of, to obtain driving or braking torques in the relative rotation between the said “inducer” and “induced” subsystem, and said method comprises the steps of:
deactivating all active electromagnets unnecessary for the rotation,
possible elimination or reduction of the residual magnetization of the electromagnets just switched off obtained by reversing the direction of the current in the coils of said electromagnets (101),
powering a number of said electromagnets (101) that can generate, on said “inducer” and/or “induced” subsystems torques useful to determine the desired motions.
